(19) United States
(12) Patent Application Publication
(10) Pub. No.: US 2026/0208805 A1
(43) Pub. Date: Jul. 23, 2026

(54) MODULAR VEHICLE

(71) Applicant: Textron Inc., Providence, RI (US)

(72) Inventors: Ricky Veldee Kemp, Augusta, GA (US); Trevor Douglas Roebuck, Evans, GA (US); Charles Daniel Dauchess, North Augusta, SC (US); Baily Guyton Wood, Dublin, GA (US)

(73) Assignee: Textron Inc., Providence, RI (US)

(21) Appl. No.: 19/032,340

(22) Filed: Jan. 20, 2025

(51) Int. Cl. B62D 63/02; B62D 65/04

(52) U.S. Cl. CPC B62D 63/025; B62D 65/04

(57) ABSTRACT

A method for producing vehicles includes providing a series of base assemblies, providing a first application kit including a first seat and an implement, and providing a second application kit including a second seat and a third seat. The base assemblies each include a base frame, a front tractive assembly coupled to the base frame, and a rear tractive assembly coupled to the base frame. The method further includes coupling the first application kit to the base frame of a first base assembly of the series of base assemblies to provide a first vehicle variant and coupling the second application kit to the base frame of a second base assembly of the series of base assemblies to provide a second vehicle variant.

### BACKGROUND

Certain vehicles are used to transport personnel and equipment between different areas. By way of example, a golf cart may transport golfers and equipment (e.g., golf bags, golf clubs, etc.) around a golf course (e.g., along a cart path, between different holes, etc.). It may be desirable to maximize the amount of storage space available within a vehicle without increasing the overall size of the vehicle (e.g., by maximizing usability of the available space onboard the vehicle). It may additionally be desirable to provide both vehicles suited for transporting golfers and vehicles suited for transporting equipment.

### SUMMARY

One embodiment relates to a method for producing vehicles. The method includes providing a series of base assemblies, providing a first application kit including a first seat and an implement, and providing a second application kit including a second seat and a third seat. The base assemblies each include a base frame, a front tractive assembly coupled to the base frame, and a rear tractive assembly coupled to the base frame. The method further includes coupling the first application kit to the base frame of a first base assembly of the series of base assemblies to provide a first vehicle variant and coupling the second application kit to the base frame of a second base assembly of the series of base assemblies to provide a second vehicle variant.

Another embodiment relates to a vehicle. The vehicle includes a chassis, a front tractive assembly coupled to the chassis and including a pair of front wheels, and a rear tractive assembly coupled to the chassis. The chassis includes a pair of frame rails extending longitudinally and each including a front portion and a rear portion and a cross member extending laterally between the frame rails and fixedly coupled to the frame rails. A first lateral distance between the front portions is less than a second lateral distance between the rear portions. The front portions of the frame rails extend between the front wheels. The rear tractive assembly include a first rear wheel and a second rear wheel, an axle coupled to the first rear wheel, an electric motor longitudinally offset from the axle, and a power transmission coupling the electric motor to the axle. The rear portions of the frame rails extend between the first rear wheel and the second rear wheel. The vehicle further includes an upper frame coupled to the frame rails and extending above the chassis and a seat coupled to the upper frame. The rear tractive assembly extends beneath the upper frame.

Still another embodiment relates to a method for producing vehicles. The method includes providing a series of base assemblies, providing a first application kit, and providing a second application kit. Each of the base assemblies includes a base frame including a pair of first frame rails that extend longitudinally and are laterally offset from one another. Each of the first frame rails include a front portion and a rear portion. A first lateral distance between the front portions of the first frame rails is less than a second lateral distance between the rear portions of the first frame rails. Each of the base assemblies further includes a front tractive assembly including a pair of front wheels and a rear tractive assembly including a pair of rear wheels. The front tractive assembly is coupled to the base frame such that the front portions of the first frame rails extend between the front wheels. The rear tractive assembly is coupled to the base frame such that the rear portions of the first frame rails extend between the rear wheels. The first application kit includes an upper frame including a second frame rail, a first seat coupled to the second frame rail, a bed pivotably coupled to the second frame rail and having a top surface configured to support a load, and a bed actuator coupled to the upper frame and the bed and configured to reposition the bed relative to the upper frame. The second application kit includes a second seat, a first seat frame coupled to the second seat, a third seat, and a second seat frame separate from the first seat frame and coupled to the third seat. The method further includes coupling the upper frame of the first application kit to the base frame of a first base assembly of the series of base assemblies to provide a first vehicle variant. In the first vehicle variant, (a) the bed is positioned rearward of the first seat, (b) the second frame rail extends longitudinally above one of the first frame rails and the rear tractive assembly, and (c) the second frame rail meets the one of the first frame rails between the front tractive assembly and the rear tractive assembly. The method further includes coupling the first seat frame and the second seat frame of the second application kit to both of the first frame rails of the base frame of a second base assembly of the series of base assemblies to provide a second vehicle variant. In the second vehicle variant, (a) the first seat frame is positioned between the front tractive assembly and the rear tractive assembly of the second base assembly, and (b) the rear tractive assembly of the second base assembly extends beneath the third seat and the second seat frame.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a vehicle, according to an exemplary embodiment.

FIG. 2 is a schematic block diagram of the vehicle of FIG. 1, according to an exemplary embodiment.

FIG. 3 is a schematic block diagram of a site monitoring and control system including a plurality of the vehicles of FIG. 1, according to an exemplary embodiment.

FIG. 4 is a front perspective view of a vehicle including a drawer in a closed position, according to an exemplary embodiment.

FIG. 5 is a front perspective view of the vehicle of FIG. 4 including the drawer in an open position, according to an exemplary embodiment.

FIG. 6 is a front perspective view of the vehicle of FIG. 4 including the drawer in the closed position, according to an exemplary embodiment.

FIG. 7 is a front perspective view of the vehicle of FIG. 4 including the drawer in the closed position, according to an exemplary embodiment.

FIG. 8 is a rear perspective view of the vehicle of FIG. 4 including the drawer in the closed position, according to an exemplary embodiment.

FIG. 9 is a right side view of the vehicle of FIG. 4 including the drawer in the closed position, according to an exemplary embodiment.

FIG. 10 is a front perspective view of the vehicle of FIG. 4 including the drawer in the open position, according to an exemplary embodiment.

FIG. 11 is a rear perspective view of the vehicle of FIG. 4 including the drawer in the open position, according to an exemplary embodiment.

FIG. 12 is a rear perspective view of the vehicle of FIG. 4 including the drawer in the open position, according to an exemplary embodiment.

FIG. 13 is a left side view of the vehicle of FIG. 4 including the drawer in the open position, according to an exemplary embodiment.

FIG. 14 is a rear view of the vehicle of FIG. 4 including the drawer in the open position, according to an exemplary embodiment.

FIG. 15 is a top view of the vehicle of FIG. 4 including the drawer in the closed position, according to an exemplary embodiment.

FIG. 16 is a top view of the vehicle of FIG. 4 including the drawer in the open position, according to an exemplary embodiment.

FIG. 17 is a right perspective view of a frame of the vehicle of FIG. 4, according to an exemplary embodiment.

FIG. 18 is a rear perspective view of the frame of the vehicle of FIG. 4, according to an exemplary embodiment.

FIG. 19 is a right side view of the frame of the vehicle of FIG. 4, according to an exemplary embodiment.

FIG. 20 is a side perspective view of the frame of the vehicle of FIG. 4, according to an exemplary embodiment.

FIG. 21 is a top perspective view of the vehicle of FIG. 4 including a bed in a transport position, according to an exemplary embodiment.

FIG. 22 is a top perspective view of the vehicle of FIG. 4 including the bed in the transport position and with a top panel of the bed removed, according to an exemplary embodiment.

FIG. 23 is a side perspective view of the vehicle of FIG. 4 including the bed in an unloading position, according to an exemplary embodiment.

FIG. 24 is a side view of the vehicle of FIG. 4 including the bed in the unloading position, according to an exemplary embodiment.

FIG. 25 is a top perspective view of the vehicle of FIG. 4 with the bed omitted, according to an exemplary embodiment.

FIG. 26 is a top view of the vehicle of FIG. 4 outfitted with a first storage assembly, according to an exemplary embodiment.

FIG. 27 is a rear perspective view of the vehicle of FIG. 4 with the first storage assembly of FIG. 26, according to an exemplary embodiment.

FIG. 28 is a side view of the vehicle of FIG. 4 with the first storage assembly of FIG. 26, according to an exemplary embodiment.

FIG. 29 is a side perspective view of the vehicle of FIG. 4 with a second storage assembly, according to an exemplary embodiment.

FIG. 30 is a side perspective view of the vehicle of FIG. 4 with the second storage assembly of FIG. 29, according to an exemplary embodiment.

FIG. 31 is a rear perspective view of the vehicle of FIG. 4 with a third storage assembly, according to an exemplary embodiment.

FIG. 32 is a rear perspective view of the vehicle of FIG. 4 with the third storage assembly of FIG. 31, according to an exemplary embodiment.

FIG. 33 is a side view of the vehicle of FIG. 4 with the third storage assembly of FIG. 31, according to an exemplary embodiment.

FIG. 34 is a side view of the vehicle of FIG. 4 with the third storage assembly of FIG. 31, according to an exemplary embodiment.

FIG. 35 is a top view of the vehicle of FIG. 4 with a fourth storage assembly, according to an exemplary embodiment.

FIG. 36 is a front perspective view of a vehicle, according to an exemplary embodiment.

FIG. 37 is a bottom perspective view of the vehicle of FIG. 36, according to an exemplary embodiment.

FIG. 38 is a top perspective view of a frame of the vehicle of FIG. 36, according to an exemplary embodiment.

FIG. 39 is a top perspective view of the frame of the vehicle of FIG. 36, according to an exemplary embodiment.

FIG. 40 is a side perspective view of the frame of the vehicle of FIG. 36, according to an exemplary embodiment.

FIG. 41 is a side perspective view of the frame of the vehicle of FIG. 36, according to an exemplary embodiment.

FIG. 42 is a rear perspective view of the frame of the vehicle of FIG. 36, according to an exemplary embodiment.

FIG. 43 is a top perspective view of the frame of the vehicle of FIG. 36, according to an exemplary embodiment.

FIG. 44 is a perspective view of a modular vehicle system including two application kits each usable with a common base assembly, according to an exemplary embodiment.

FIG. 45 is a perspective view illustrating both of the application kits of FIG. 44 overlaid onto the common base assembly, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle configured as a golf cart utilizes an electric drivetrain. Specifically, the electric drivetrain includes a battery pack including lithium-ion batteries. Other golf carts utilize lead acid batteries, which are less space efficient than lithium-ion batteries. Accordingly, the battery pack of the golf cart is capable of providing similar performance to the other golf carts while requiring less space.

The golf cart of the exemplary embodiment utilizes this vacant space for storage. The golf cart includes front row seating and a bed behind the front row seating. The battery pack of the golf cart is positioned directly beneath the seat, leaving an unoccupied area rearward of the battery pack, forward of a rear tractive assembly, and beneath the bed. Positioned within this space is a storage compartment or drawer. This drawer extends laterally across a body of the vehicle, and a portion of the drawer defines a side of the body. The drawer is repositionable between a retracted position in which the drawer is contained within the body and beneath the bed, and an extended position in which the drawer can be accessed by a user standing next to the golf cart.

The golf cart may include a bed having a top surface that supports a load. The golf cart may utilize space beneath this bed for additional storage. The golf cart may include storage bins that are coupled to the bed and extend through and below the bed. The golf cart may include storage bins that are coupled to the frame and positioned beneath the bed. The golf cart may include storage drawers that are slidably coupled to the frame beneath the bed and that pull out from under the bed when opened.

A modular vehicle system may include two or more vehicle variants, each suited to a particular application. The vehicle variants may have a common base assembly that is the same in each variant. The vehicles in the system may be produced by taking one of the common base assemblies and applying an application kit that is specific to the desired application of the vehicle. In this way, the complexity and inventory required to manufacture multiple vehicle variants may be reduced.

### Overall Vehicle

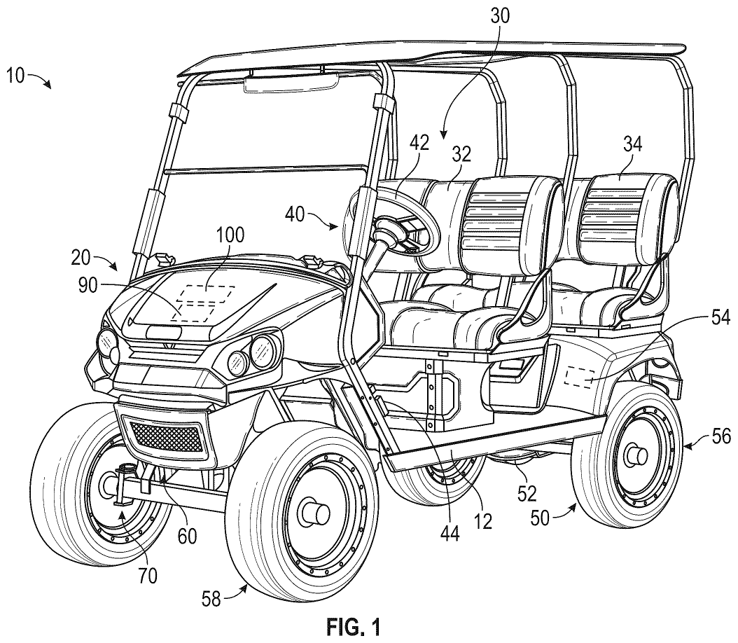

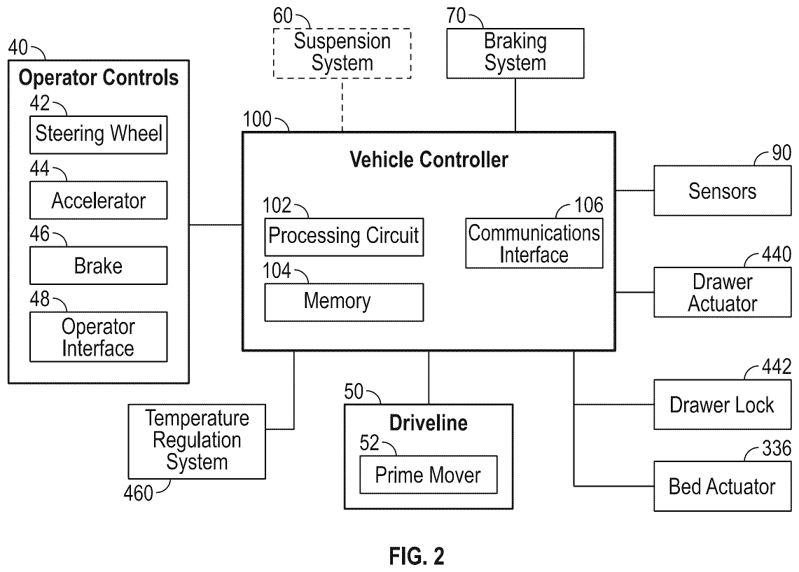

As shown in FIGS. 1 and 2, a machine or vehicle, shown as vehicle 10, includes a chassis, shown as frame 12; a body assembly, shown as body 20, coupled to the frame 12 and having an occupant portion or section, shown as occupant seating area 30; operator input and output devices, shown as operator controls 40, that are disposed within the occupant seating area 30; a drivetrain, shown as driveline 50, coupled to the frame 12 and at least partially disposed under the body 20; a vehicle suspension system, shown as suspension system 60, coupled to the frame 12 and one or more components of the driveline 50; a vehicle braking system, shown as braking system 70, coupled to one or more components of the driveline 50 to facilitate selectively braking the one or more components of the driveline 50; one or more first sensors, shown as sensors 90; and a control system, shown as vehicle controller 100, coupled to the operator controls 40, the driveline 50, the suspension system 60, the braking system 70, and the sensors 90. In some embodiments, the vehicle 10 includes more or fewer components.

According to an exemplary embodiment, the vehicle 10 is an off-road machine or vehicle. In some embodiments, the off-road machine or vehicle is a lightweight or recreational machine or vehicle such as a golf vehicle (e.g., a golf cart), an all-terrain vehicle (“ATV”), a utility task vehicle (“UTV”), a low speed vehicle (“LSV”), and/or another type of lightweight or recreational machine or vehicle. In some embodiments, the off-road machine or vehicle is a chore product such as a lawnmower, a turf mower, a push mower, a ride-on mower, a stand-on mower, aerator, turf sprayers, bunker rake, and/or another type of chore product (e.g., that may be used on a golf course).

According to the exemplary embodiment shown in FIG. 1, the occupant seating area 30 includes a plurality of rows of seating including a first row of seating, shown as front row seating 32, and a second row of seating, shown as rear row seating 34. In some embodiments, the occupant seating area 30 includes a third row of seating or intermediate/middle row seating positioned between the front row seating 32 and the rear row seating 34. According to the exemplary embodiment shown in FIG. 1, the rear row seating 34 is facing forward. In some embodiments, the rear row seating 34 is facing rearward. In some embodiments, the occupant seating area 30 does not include the rear row seating 34. In some embodiments, in addition to or in place of the rear row seating 34, the vehicle 10 includes one or more rear accessories. Such rear accessories may include a golf bag rack, a bed, a cargo body (e.g., for a drink cart), and/or other rear accessories.

According to an exemplary embodiment, the operator controls 40 are configured to provide an operator with the ability to control one or more functions of and/or provide commands to the vehicle 10 and the components thereof (e.g., turn on, turn off, drive, turn, brake, engage various operating modes, raise/lower an implement, etc.). As shown in FIGS. 1 and 2, the operator controls 40 include a steering interface (e.g., a steering wheel, joystick(s), etc.), shown steering wheel 42, an accelerator interface (e.g., a pedal, a throttle, etc.), shown as accelerator 44, a braking interface (e.g., a pedal), shown as brake 46, and one or more additional interfaces, shown as operator interface 48. The operator interface 48 may include one or more displays and one or more input devices. The one or more displays may be or include a touchscreen, a LCD display, a LED display, a speedometer, gauges, warning lights, etc. The one or more input device may be or include buttons, switches, knobs, levers, dials, etc.

According to an exemplary embodiment, the driveline 50 is configured to propel the vehicle 10. As shown in FIGS. 1 and 2, the driveline 50 includes a primary driver, shown as prime mover 52, an energy storage device, shown as energy storage 54, a first tractive assembly (e.g., axles, wheels, tracks, differentials, etc.) or rear axle assembly, shown as rear tractive assembly 56, and a second tractive assembly (e.g., axles, wheels, tracks, differentials, etc.) or front axle assembly, shown as front tractive assembly 58. In some embodiments, the driveline 50 is a conventional driveline whereby the prime mover 52 is an internal combustion engine and the energy storage 54 is a fuel tank. The internal combustion engine may be a spark-ignition internal combustion engine or a compression-ignition internal combustion engine that may use any suitable fuel type (e.g., diesel, ethanol, gasoline, natural gas, propane, etc.). In some embodiments, the driveline 50 is an electric driveline whereby the prime mover 52 is an electric motor and the energy storage 54 is a battery system. In some embodiments, the driveline 50 is a fuel cell electric driveline whereby the prime mover 52 is an electric motor and the energy storage 54 is a fuel cell (e.g., that stores hydrogen, that produces electricity from the hydrogen, etc.). In some embodiments, the driveline 50 is a hybrid driveline whereby (i) the prime mover 52 includes an internal combustion engine and an electric motor/generator and (ii) the energy storage 54 includes a fuel tank and/or a battery system. According to the exemplary embodiment shown in FIG. 1, the rear tractive assembly 56 includes rear tractive elements and the front tractive assembly 58 includes front tractive elements that are configured as wheels. In some embodiments, the rear tractive elements and/or the front tractive elements are configured as tracks.

According to an exemplary embodiment, the prime mover 52 is configured to provide power to drive the rear tractive assembly 56 and/or the front tractive assembly 58 (e.g., to provide front-wheel drive, rear-wheel drive, four-wheel drive, and/or all-wheel drive operations). In some embodiments, the driveline 50 includes a transmission device (e.g., a gearbox, a continuous variable transmission (“CVT”), etc.) positioned between (a) the prime mover 52 and (b) the rear tractive assembly 56 and/or the front tractive assembly 58. The rear tractive assembly 56 and/or the front tractive assembly 58 may include a drive shaft, a differential, and/or an axle. In some embodiments, the rear tractive assembly 56 and/or the front tractive assembly 58 include two axles or a tandem axle arrangement. In some embodiments, the rear tractive assembly 56 and/or the front tractive assembly 58 are steerable (e.g., using the steering wheel 42). In some embodiments, both the rear tractive assembly 56 and the front tractive assembly 58 are fixed and not steerable (e.g., employ skid steer operations).

In some embodiments, the driveline 50 includes a plurality of prime movers 52. By way of example, the driveline 50 may include a first prime mover 52 that drives the rear tractive assembly 56 and a second prime mover 52 that drives the front tractive assembly 58. By way of another example, the driveline 50 may include a first prime mover 52 that drives a first one of the front tractive elements, a second prime mover 52 that drives a second one of the front tractive elements, a third prime mover 52 that drives a first one of the rear tractive elements, and/or a fourth prime mover 52 that drives a second one of the rear tractive elements. By way of still another example, the driveline 50 may include a first prime mover 52 that drives the front tractive assembly 58, a second prime mover 52 that drives a first one of the rear tractive elements, and a third prime mover 52 that drives a second one of the rear tractive elements. By way of yet another example, the driveline 50 may include a first prime mover 52 that drives the rear tractive assembly 56, a second prime mover 52 that drives a first one of the front tractive elements, and a third prime mover 52 that drives a second one of the front tractive elements.

According to an exemplary embodiment, the suspension system 60 includes one or more suspension components (e.g., shocks, dampers, springs, etc.) positioned between the frame 12 and one or more components (e.g., tractive elements, axles, etc.) of the rear tractive assembly 56 and/or the front tractive assembly 58. In some embodiments, the vehicle 10 does not include the suspension system 60.

According to an exemplary embodiment, the braking system 70 includes one or more braking components (e.g., disc brakes, drum brakes, in-board brakes, axle brakes, etc.) positioned to facilitate selectively braking one or more components of the driveline 50. In some embodiments, the one or more braking components include (i) one or more front braking components positioned to facilitate braking one or more components of the front tractive assembly 58 (e.g., the front axle, the front tractive elements, etc.) and (ii) one or more rear braking components positioned to facilitate braking one or more components of the rear tractive assembly 56 (e.g., the rear axle, the rear tractive elements, etc.). In some embodiments, the one or more braking components include only the one or more front braking components. In some embodiments, the one or more braking components include only the one or more rear braking components. In some embodiments, the one or more front braking components include two front braking components, one positioned to facilitate braking each of the front tractive elements. In some embodiments, the one or more rear braking components include two rear braking components, one positioned to facilitate braking each of the rear tractive elements.

The sensors 90 may include various sensors positioned about the vehicle 10 to acquire vehicle information or vehicle data regarding operation of the vehicle 10 and/or the location thereof. By way of example, the sensors 90 may include an accelerometer, a gyroscope, a compass, a position sensor (e.g., a GPS sensor, etc.), an inertial measurement unit (“IMU”), suspension sensor(s), wheel sensors, an audio sensor or microphone, a camera, an optical sensor, a proximity detection sensor, and/or other sensors to facilitate acquiring vehicle information or vehicle data regarding operation of the vehicle 10 and/or the location thereof. According to an exemplary embodiment, one or more of the sensors 90 are configured to facilitate detecting and obtaining vehicle telemetry data including position of the vehicle 10, whether the vehicle 10 is moving, travel direction of the vehicle 10, slope of the vehicle 10, speed of the vehicle 10, vibrations experienced by the vehicle 10, sounds proximate the vehicle 10, suspension travel of components of the suspension system 60, and/or other vehicle telemetry data.

The vehicle controller 100 may be implemented as a general-purpose processor, an application specific integrated circuit (“ASIC”), one or more field programmable gate arrays (“FPGAs”), a digital-signal-processor (“DSP”), circuits containing one or more processing components, circuitry for supporting a microprocessor, a group of processing components, or other suitable electronic processing components. According to the exemplary embodiment shown in FIG. 2, the vehicle controller 100 includes a processing circuit 102, a memory 104, and a communications interface 106. The processing circuit 102 may include an ASIC, one or more FPGAs, a DSP, circuits containing one or more processing components, circuitry for supporting a microprocessor, a group of processing components, or other suitable electronic processing components. In some embodiments, the processing circuit 102 is configured to execute computer code stored in the memory 104 to facilitate the activities described herein. The memory 104 may be any volatile or non-volatile or non-transitory computer-readable storage medium capable of storing data or computer code relating to the activities described herein. According to an exemplary embodiment, the memory 104 includes computer code modules (e.g., executable code, object code, source code, script code, machine code, etc.) configured for execution by the processing circuit 102. In some embodiments, the vehicle controller 100 may represent a collection of processing devices. In such cases, the processing circuit 102 represents the collective processors of the devices, and the memory 104 represents the collective storage devices of the devices.

In one embodiment, the vehicle controller 100 is configured to selectively engage, selectively disengage, control, or otherwise communicate with components of the vehicle 10 (e.g., via the communications interface 106, a controller area network (“CAN”) bus, etc.). According to an exemplary embodiment, the vehicle controller 100 is coupled to (e.g., communicably coupled to) components of the operator controls 40 (e.g., the steering wheel 42, the accelerator 44, the brake 46, the operator interface 48, etc.), components of the driveline 50 (e.g., the prime mover 52), components of the braking system 70, and the sensors 90. By way of example, the vehicle controller 100 may send and receive signals (e.g., control signals, location signals, etc.) with the components of the operator controls 40, the components of the driveline 50, the components of the braking system 70, the sensors 90, and/or remote systems or devices (via the communications interface 106 as described in greater detail herein).

### Site Monitoring and Control System

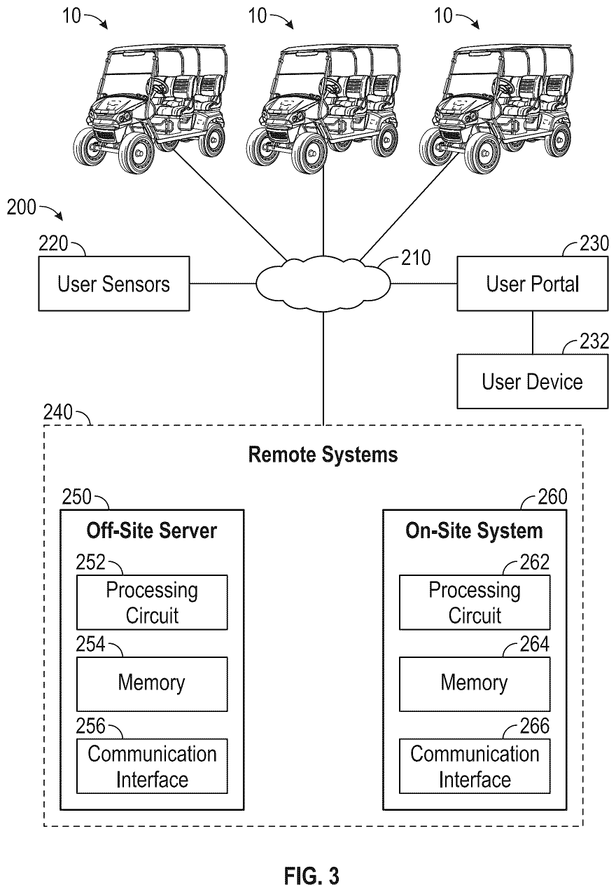

As shown in FIG. 3, a monitoring and control system, shown as site monitoring and control system 200, includes one or more vehicles 10; one or more second sensors, shown as user sensors 220, positioned remote or separate from the vehicles 10; an operator interface, shown as user portal 230, positioned remote or separate from the vehicles 10; an external or remote user device, shown as user device 232, positioned remote or separate from the vehicles 10; and one or more external processing systems, shown as remote systems 240, positioned remote or separate from the vehicles 10. The vehicles 10, the user sensors 220, the user portal 230, and the remote systems 240 communicate via one or more communications protocols (e.g., Bluetooth, Wi-Fi, cellular, radio, through the Internet, etc.) through a network, shown as communications network 210.

The user sensors 220 may be or include one or more sensors that are carried by or worn by an operator of one of the vehicles 10. By way of example, the user sensors 220 may be or include a wearable sensor (e.g., a smartwatch, a fitness tracker, a pedometer, hear rate monitor, etc.) and/or a sensor that is otherwise carried by the operator (e.g., a smartphone, etc.) that facilitates acquiring and monitoring operator data (e.g., physiological conditions such a temperature, heartrate, breathing patterns, etc. ; location; movement; etc.) regarding the operator. The user sensors 220 may communicate directly with the vehicles 10, directly with the remote systems 240, and/or indirectly with the remote systems 240 (e.g., through the vehicles 10 as an intermediary).

The user portal 230 may be configured to facilitate operator access to dashboards including the vehicle data, the operator data, information available at the remote systems 240, etc. to manage and operate the site (e.g., golf course) such as for advanced scheduling purposes, to identify persons braking course guidelines or rules, to monitor locations of the vehicles 10, etc. The user portal 230 may also be configured to facilitate operator implementation of configurations and/or parameters for the vehicles 10 and/or the site (e.g., setting speed limits, setting geofences, etc.). As shown in FIG. 3, the user portal 230 is accessible via the user device 232. The user device 232 may be or include a computer, laptop, smartphone, tablet, or the like. The user portal 230 and the user device 232 may communicate via one or more communications protocols (e.g., Bluetooth, Wi-Fi, cellular, radio, through the Internet, wired connection, etc.) through a network (e.g., a CAN bus, the communications network 210, etc.). The user device 232 includes a display (e.g., a screen, etc.) configured to display one or more graphical user interfaces (“GUIs”) of the user portal 230.

As shown in FIG. 3, the remote systems 240 include a first remote system, shown as off-site server 250, and a second remote system, shown as on-site system 260 (e.g., in a clubhouse of a golf course, on the golf course, etc.). In some embodiments, the remote systems 240 include only one of the off-site server 250 or the on-site system 260. As shown in FIG. 3, (a) the off-site server 250 includes a processing circuit 252, a memory 254, and a communications interface 256 and (b) the on-site system 260 includes a processing circuit 262, a memory 264, and a communications interface 266.

According to an exemplary embodiment, the remote systems 240 (e.g., the off-site server 250 and/or the on-site system 260) are configured to communicate with the vehicles 10 and/or the user sensors 220 via the communications network 210. By way of example, the remote systems 240 may receive the vehicle data from the vehicles 10 and/or the operator data from the user sensors 220. The remote systems 240 may be configured to perform back-end processing of the vehicle data and/or the operator data. The remote systems 240 may be configured to monitor various global positioning system (“GPS”) information and/or real-time kinematics (“RTK”) information (e.g., position/location, speed, direction of travel, geofence related information, etc.) regarding the vehicles 10 and/or the user sensors 220. The remote systems 240 may be configured to transmit information, data, commands, and/or instructions to the vehicles 10. By way of example, the remote systems 240 may be configured to transmit GPS data and/or RTK data based on the GPS information and/or RTK information to the vehicles 10 (e.g., which the vehicle controllers 100 may use to make control decisions). By way of another example, the remote systems 240 may send commands or instructions to the vehicles 10 to implement.

According to an exemplary embodiment, the remote systems 240 (e.g., the off-site server 250 and/or the on-site system 260) are configured to communicate with the user portal 230 via the communications network 210. By way of example, the user portal 230 may facilitate (a) accessing the remote systems 240 to access data regarding the vehicles 10 and/or the operators thereof and/or (b) configuring or setting operating parameters for the vehicles 10 (e.g., geofences, speed limits, times of use, permitted operators, etc.). Such operating parameters may be propagated to the vehicles 10 by the remote systems 240 (e.g., as updates to settings) and/or used for real time control of the vehicles 10 by the remote systems 240.

### Vehicle Structure

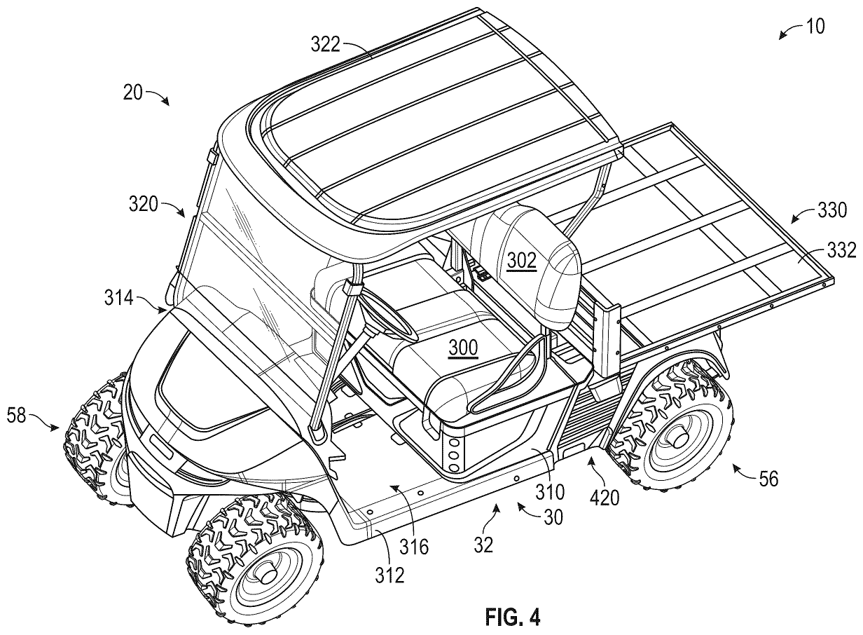

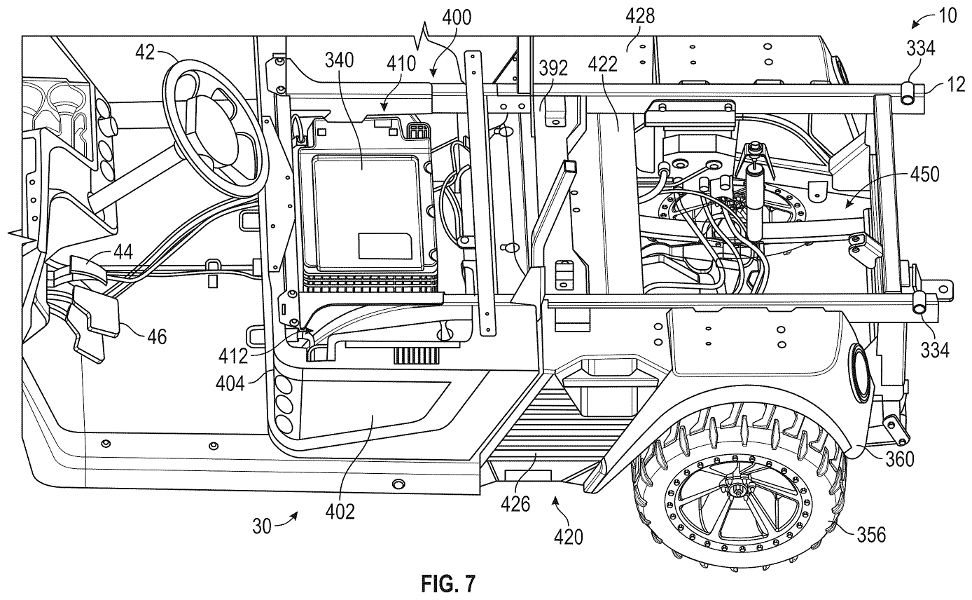

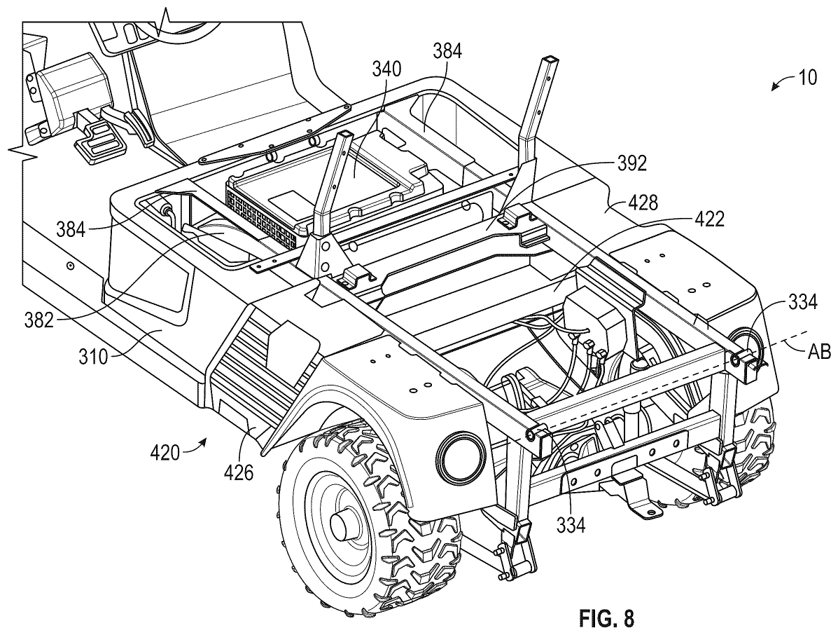

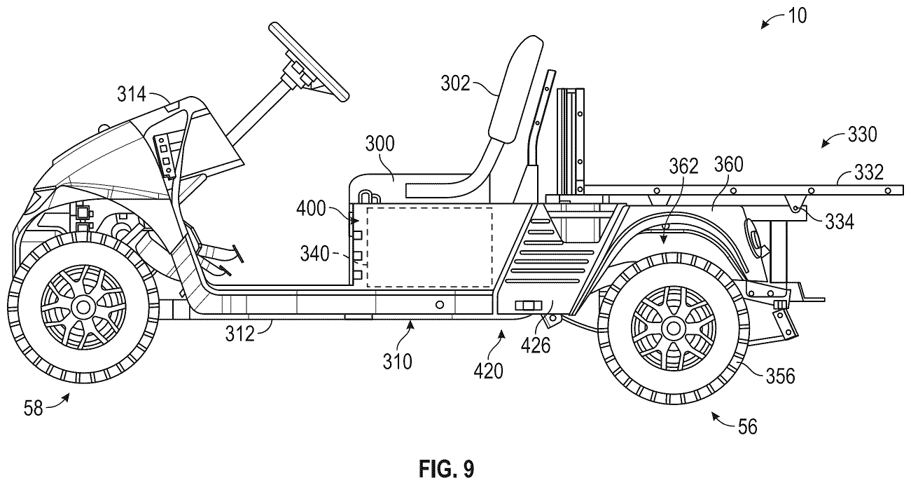

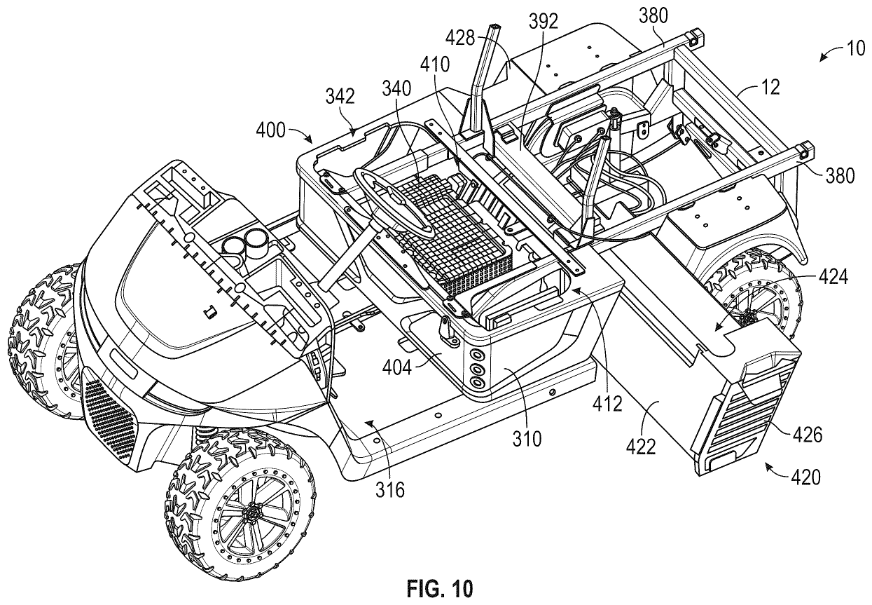

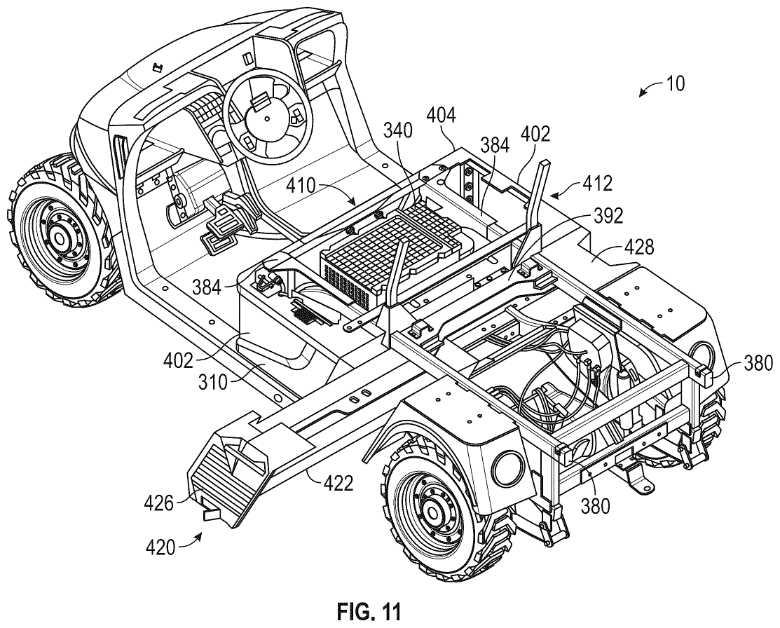

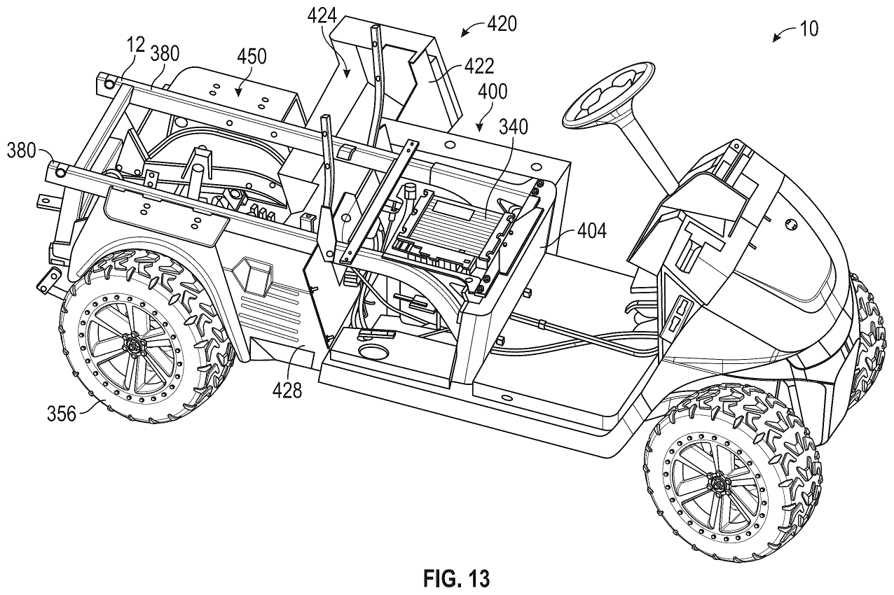

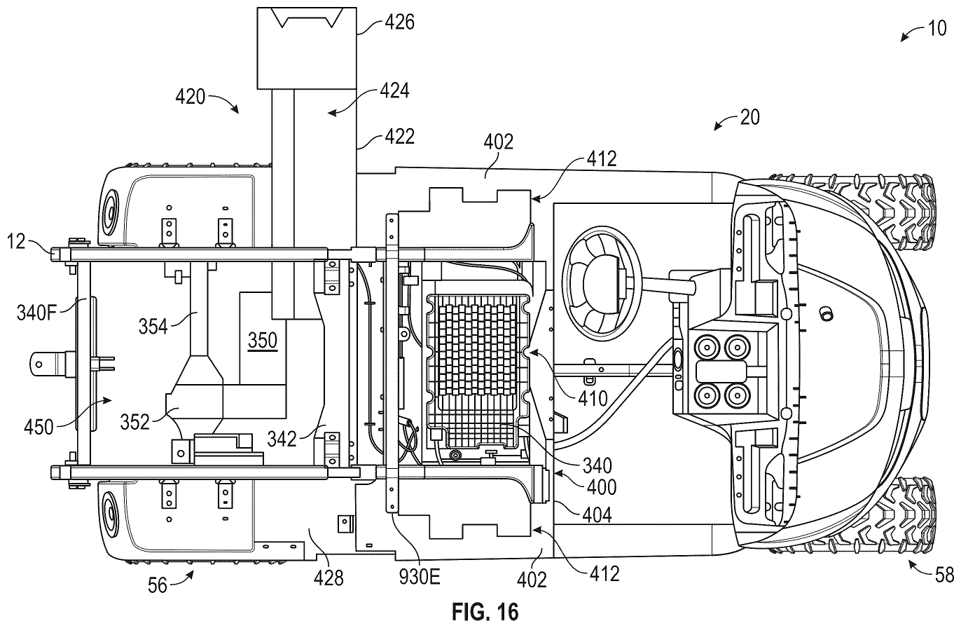

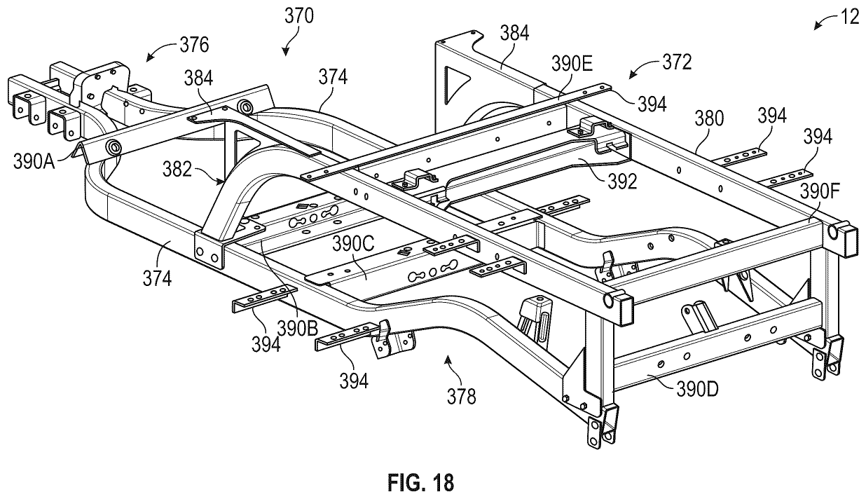

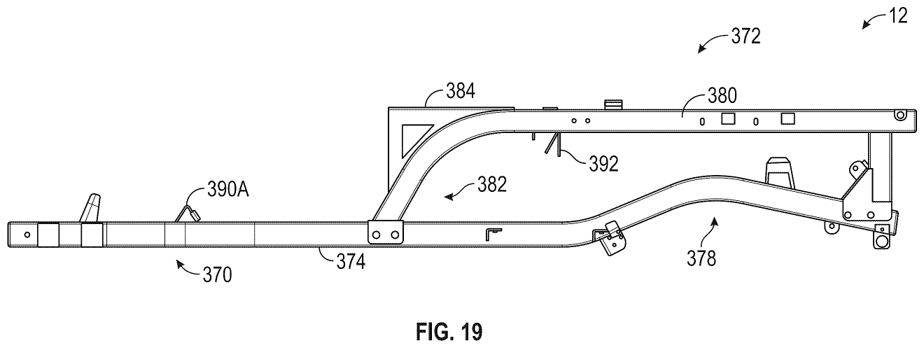

Referring to FIGS. 4-19, the vehicle 10 is shown according to an exemplary embodiment. The vehicle 10 of FIGS. 4-19 may be substantially similar to the vehicle 10 of FIG. 1 except as otherwise specified herein. In some embodiments, the vehicle 10 is configured as a golf vehicle.

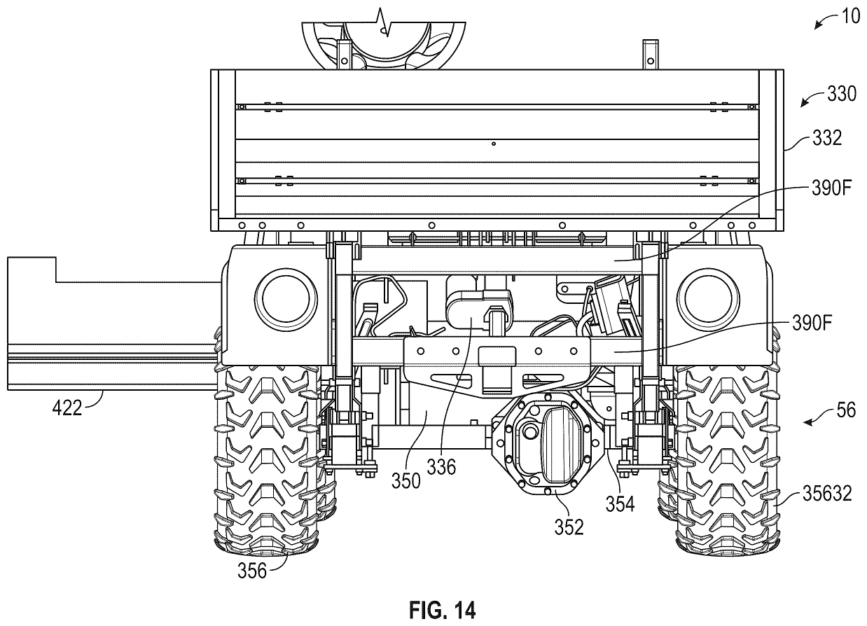

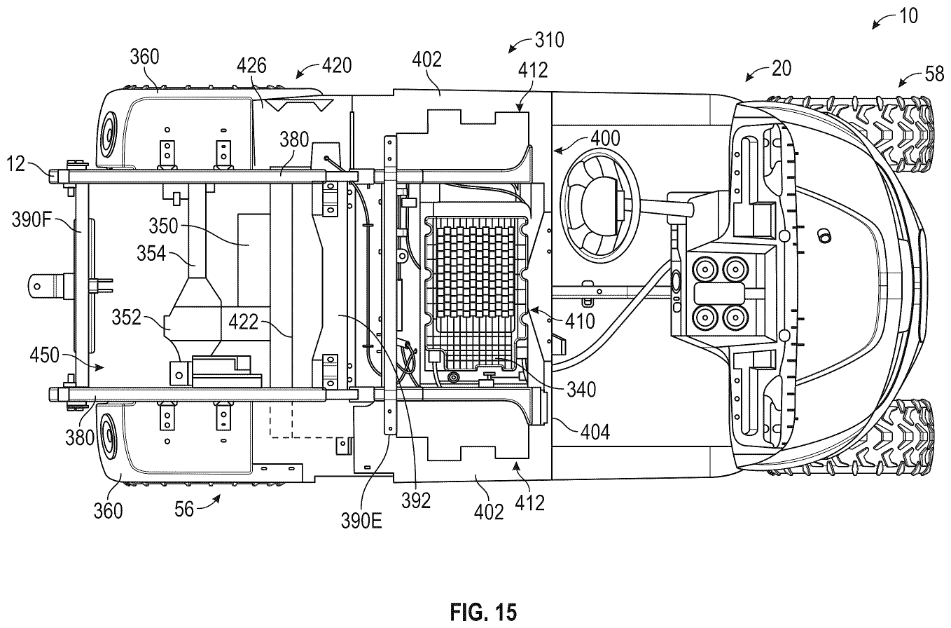

As shown in FIGS. 14 and 15, the vehicle 10 includes the front row seating 32, and the rear row seating 34 is omitted. The front row seating 32 extends laterally across the body 20, from a right side of the body 20 (e.g., a first lateral side) to a left side of the body 20 (e.g., a second lateral side). Accordingly, the front row seating 32 may provide at least two seats (e.g., for an operator or driver and one or more passengers. The front row seating 32 includes a first seat portion, shown as seat bottom 300, and a second set portion, shown as seat back 302. The seat bottom 300 extends substantially horizontally and supports the bottom of the occupant. The seat back 302 extends substantially vertically and supports the back of the occupant.

The body 20 includes an under-seat portion, shown as seat box 310, that extends directly beneath and supports the seat bottom 300. The seat box 310 has a pair of lateral sides that extend along the left and right sides of the body 20, respectively, and a front side that extends between the lateral sides. The body 20 further includes a horizontal portion, shown as floor 312, that extends substantially horizontally, forward from the seat box 310 and toward a front end of the vehicle 10. The floor 312 may support the feet of an occupant as the occupant steps into the vehicle 10 (e.g., to enter or exit the front row seating 32). The body 20 further includes a front assembly or dashboard, shown as dash assembly 314. The dash assembly 314 is positioned at the front end of the floor 312 and extends upward from the floor 312. The dash assembly 314 may support and/or include one or more of the operator controls 40 (e.g., the steering wheel 42, the accelerator 44, the brake 46, etc.).

The body 20 defines a volume, shown as foot volume 316, that is sized and positioned to receive the lower body (e.g., feet and legs) of any occupants seated in the front row seating 32. The foot volume 316 is defined between the front side of the seat box 310, the top surface of the floor 312, and the rear side of the dash assembly 314. Accordingly, the foot volume 316 extends forward of and below the seat bottom 300. The foot volume 316 may extend laterally across and through the entire vehicle 10 to facilitate unobstructed lateral access to and egress from the vehicle 10.

The vehicle 10 further includes a transparent barrier (e.g., a window, a windscreen, a windshield, etc.), shown as windshield 320. The windshield 320 is coupled to the dash assembly 314 and extends upward from the dash assembly 314, substantially perpendicular to the direction of travel of the vehicle 10 (e.g., substantially laterally and vertically). The windshield 320 may protect the occupants from wind and debris while the vehicle 10 is driving. In some embodiments, the windshield 320 is removable. The windshield 320 may be omitted from various figures for clarity of illustration.

The vehicle 10 further includes a topper, shown as roof 322. The roof 322 is coupled to the body 20 (e.g., through the windshield 320 and/or the seat back 302). The roof 322 extends substantially horizontally above the front row seating 32, protecting the occupants from falling debris (e.g., rain, dust, sticks, etc.) and sunlight. In some embodiments, the roof 322 is removable. The roof 322 may be omitted from various figures for clarity of illustration.

In place of the rear row seating 34, the vehicle 10 includes an implement (e.g., a dump box, a dump bed, a cargo bed, etc.), shown as bed assembly 330. The bed assembly 330 is coupled to the frame 12 and positioned rearward of the front row seating 32. The bed assembly 330 is configured to store cargo (e.g., sporting equipment such as golf clubs or firearms, material such as stone, dirt, or mulch, etc.) for transportation by the vehicle 10.

As shown, the bed assembly 330 includes a container (e.g., a vessel, a bed, a bucket, a dumper, a cargo bed, etc.), shown as bed 332, that is pivotally coupled to a pair of bosses or bushings 334 of the frame 12. The bushings 334 align with one another to permit the bed 332 to pivot relative to the frame 12 about an axis AB. The axis AB is positioned at a rear end of the vehicle 10 and extends laterally. Accordingly, the bed 332 is repositionable between a first position, storage position, lowered position, or transport position, shown in FIG. 4, and a second position, dumping position, raised position, or unloading position. In the transport position, the bed 332 is configured to support cargo. In the unloading position, the bed 332 is tilted upward relative to the transport position to facilitate dumping the cargo out of the bed 332.

As shown in FIGS. 2 and 14, the bed assembly 330 further includes an actuator (e.g., an electric linear actuator), shown as bed actuator 336, coupled to the frame 12 and the bed 332. In some embodiments, the bed actuator 336 is a linear actuator (e.g., an electric linear actuator, a hydraulic cylinder, etc.). The bed actuator 336 is configured to extend or retract to reposition the bed 332 between the transport position and the unloading position. By way of example, the bed actuator 336 may be controlled through the operator interface 48 and/or the user device 232. By including a powered actuator, the bed 332 may be moved to a desired position without requiring manual effort or with only minimal manual effort. In other embodiments, the bed 332 is manually repositioned. In yet other embodiments, the bed 332 is fixed in the transport position (i.e., is not movable).

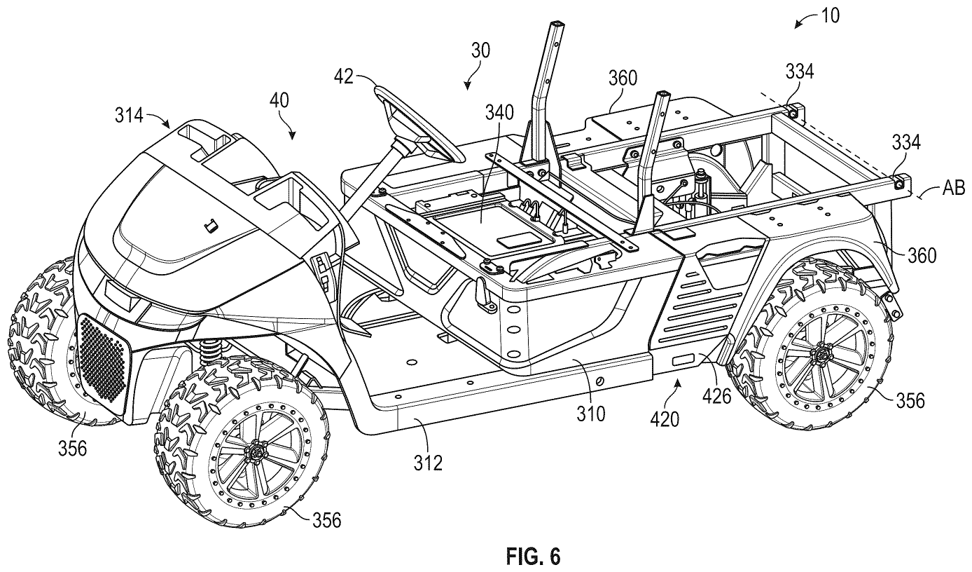

In some embodiments, the driveline 50 of the vehicle 10 is partially or completely electric. As shown in FIG. 6, the energy storage 54 includes an energy storage device, shown as battery pack 340, that provides some or all of the energy used to propel the vehicle 10. The battery pack 340 may store energy (e.g., as chemical energy) and provide the stored energy as electrical energy (e.g., direct current (DC) electrical energy) to the prime mover 52. Specifically, the electrical energy from the battery pack 340 is provided to the rear tractive assembly 56 (e.g., directly or through one or more power electronics) to power the rear tractive assembly 56 and propel the vehicle 10.

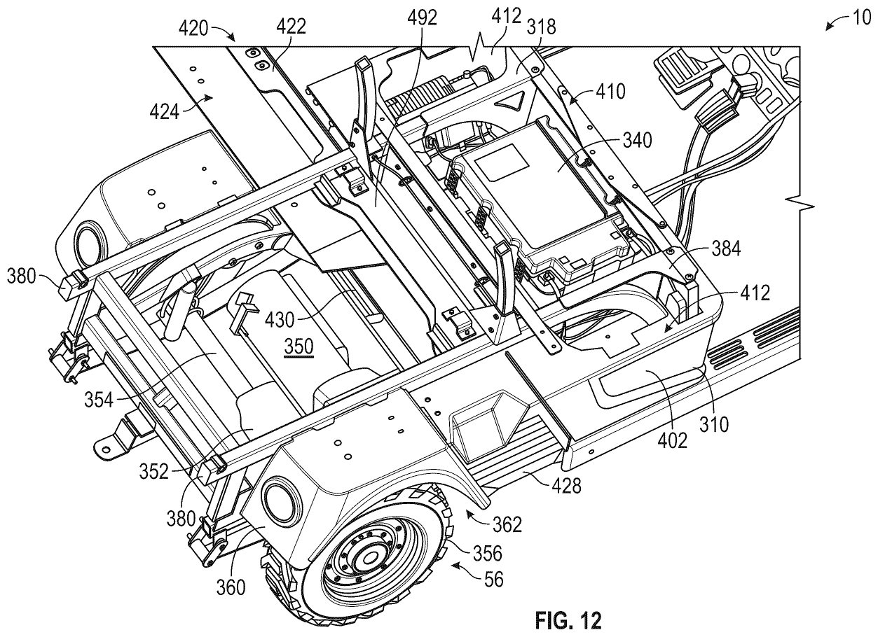

Referring to FIGS. 12, 14-16, and 25, the rear tractive assembly 56 is shown according to an exemplary embodiment. The rear tractive assembly 56 may form a self-contained electronic axle assembly including a prime mover 52. As shown, the rear tractive assembly 56 includes an actuator, shown as electric motor 350, a gearbox, shown as power transmission 352, a pair of shafts, shown as axles 354, and a pair of tractive elements, shown as wheels 356. Specifically, the electric motor 350 is coupled to the power transmission 352, the power transmission 352 is coupled to the axles 354, and each axle 354 is coupled to one of the wheels 356.

In operation, the rear tractive assembly 56 receives electrical energy from the battery pack 340 and drives the wheels 356 to propel the vehicle 10. Specifically, the electric motor 350 may receive electrical energy and provide a rotational mechanical energy output to the power transmission 352. The power transmission 352 transfers the rotational mechanical energy to the axles 354. By way of example, the power transmission 352 may include a gearbox and/or differential that distributes the rotational mechanical energy between the axles 354. Each axle 354 transfers the rotational mechanical energy to one of the wheels 356. The wheels 356 then rotate while engaging the ground to propel the vehicle 10.

Referring to FIGS. 6-13, the body 20 includes a pair of rear body sections, shown as fenders 360, coupled to the frame 12. The fenders 360 are positioned along opposite lateral sides of the vehicle 10, rearward of the front row seating 32 and the seat box 310 and beneath the bed 332. Each of the fenders 360 defines a recess or volume, shown as wheel well 362. Each wheel well 362 receives one of the wheels 356 of the rear tractive assembly 56. Accordingly, each of the fenders 360 extend above one of the wheels 356 of the rear tractive assembly 56. The fenders 360 may facilitate capturing any debris (e.g., mud, rocks, etc.) that is released from the wheels 356 along an upward trajectory as the wheels 356 rotate.

As shown in FIG. 6, the front tractive assembly 58 also includes a pair of the wheels 356. However, the wheels 356 of the front tractive assembly 58 may not be directly powered by the prime mover 52 (e.g., may be free spinning). The wheels 356 of the front tractive assembly 58 may be rotatable about respective vertical axes to facilitate steering the vehicle 10.

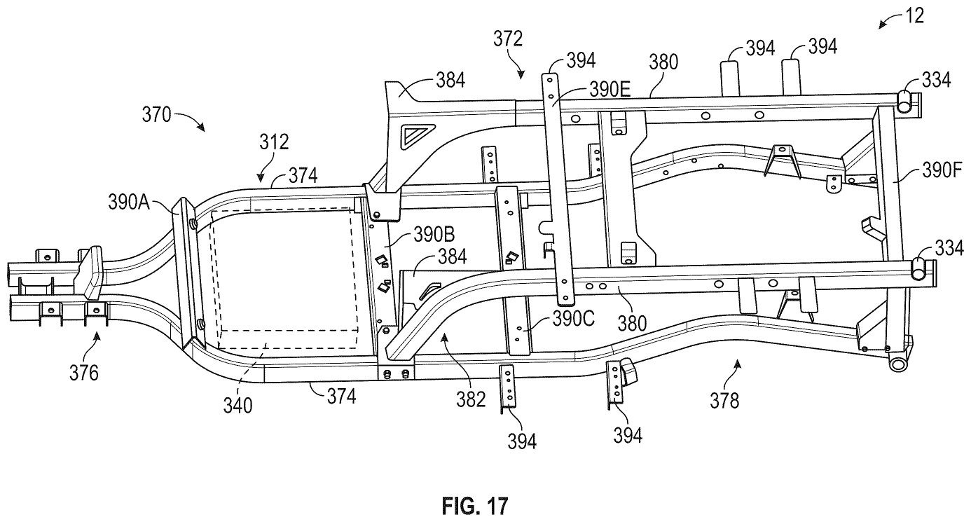

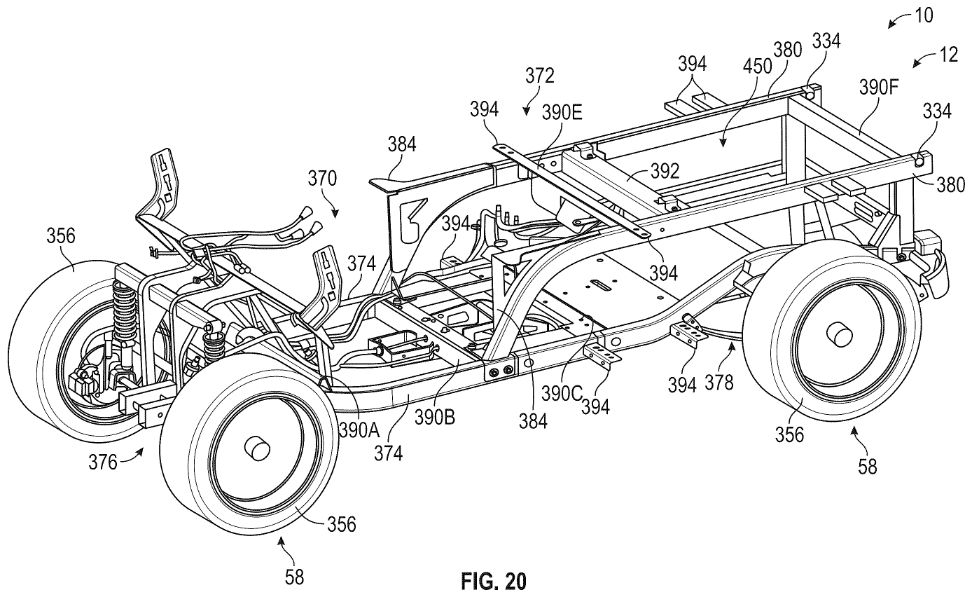

Referring to FIGS. 17-19, the frame 12 of the vehicle 10 is shown according to an exemplary embodiment. FIG. 20 illustrates the rear tractive assembly 56 and the front tractive assembly 58 mounted on the frame 12. The frame 12 includes a series of frame members that are fixedly coupled to one another to form the frame 12. By way of example, the frame members may be fastened to one another (e.g., using one or more fasteners (e.g., bolts, rivets, etc.). By way of another example, the frame members may be welded to one another to form a weldment.

The frame 12 includes a bottom portion or lower portion 370 and a top portion or upper portion 372. The lower portion 370 extends generally horizontally and generally within a horizontal plane common to the floor 312. The lower portion 370 may support the floor 312, the front tractive assembly 58, and the rear tractive assembly 56. The upper portion 372 extends upward from the lower portion 370 and extends generally within a horizontal plane above the floor 312. The upper portion 372 may support the front row seating 32, the seat box 310, and the bed assembly 330.

The lower portion 370 includes a pair of longitudinal frame members, shown as lower frame rails 374. The lower frame rails 374 are laterally offset from one another and are symmetrical about a longitudinal and vertical center plane of the vehicle 10. The lower frame rails 374 extend generally longitudinally along the length of the vehicle 10. A front portion or narrowed portion 376 of each lower frame rail 374 near a front end of the vehicle 10 extends laterally inward, decreasing a distance between the lower frame rails 374. The narrowed portions 376 may permit the lower frame rails 374 to pass between the wheels 356 of the front tractive assembly 58 and provide clearance for the wheels 356 to facilitate steering. Each lower frame rail 374 includes a rear portion or arched portion 378 that arches upward near the rear end of the vehicle 10, forming a downward-facing recess. The arched portions 378 receive the rear tractive assembly 56.

The upper portion 372 includes a pair of longitudinal frame members, shown as upper frame rails 380. The upper frame rails 380 are laterally offset from one another and are symmetrical about the longitudinal and vertical center plane of the vehicle 10. The upper frame rails 380 extend generally longitudinally along the length of the vehicle 10. A front portion or upright portion 382 of each upper frame rail 380 extends upward and rearward from a corresponding lower frame rail 374, coupling the upper frame rail 380 to the lower frame rail 374. A bushing 334 is fixedly coupled to a rear end portion of each upper frame rail 380. The bushings 334 pivotably couple the bed 332 to the upper frame rails 380.

A support, shown as bracket 384, is fixedly coupled to an interior surface of each upright portion 382 and extends above the upper frame rail 380 to form a substantially horizontal mounting surface. The seat box 310 is coupled to this mounting surface, such that the bracket 384 couples the seat box 310 to the frame 12. The brackets 384 couple the seat bottom 300 to the upper frame rails 380, such that the upper frame rails 380 and the brackets 384 support the seat bottom 300.

A series of lateral members, shown as cross members 390A, 390B, 390C, 390D, 390E, and 390F and referred to generally as cross members 390, extend laterally between the lower frame rails 374 or laterally between the upper frame rails 380. The cross members 390 maintain a fixed distance between the lower frame rails 374 and between the upper frame rails 380. An additional cross member, shown as drawer support 392, extends laterally between the upper frame rails 380 and is fixedly coupled to the upper frame rails 380. A series of supports, shown as mounting brackets 394, extend laterally outward from the lower frame rails 374 and the upper frame rails 380 and couple the body 20 to the frame 12. Some of the mounting brackets 394 are formed individually, and other mounting brackets 394 are integrally formed as a single, continuous piece with the one of the cross members 390.

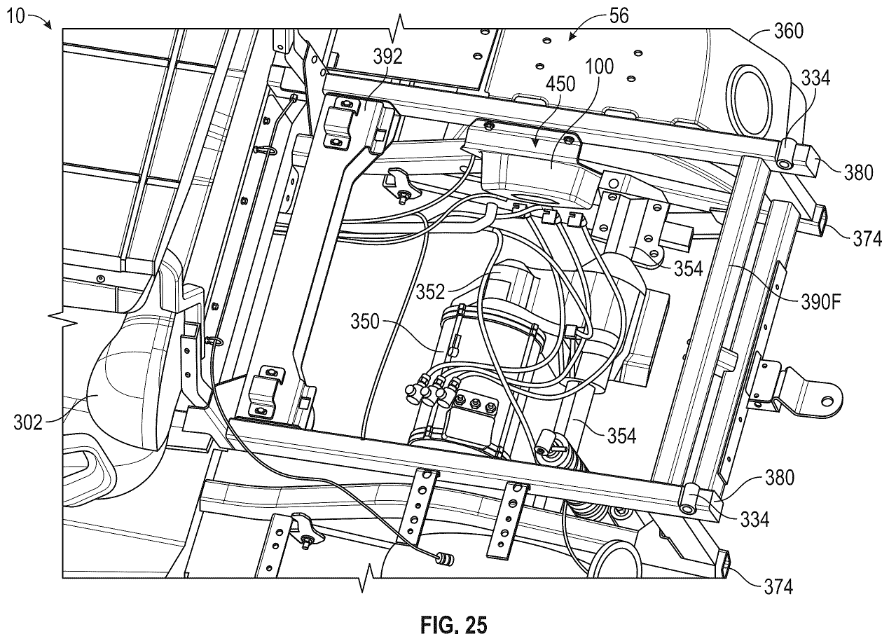

Referring to FIG. 25, the vehicle controller 100 is fixedly coupled to the frame 12. The vehicle controller 100 extends along an inner surface of the upper frame rails 380 and the lower frame rails 374 and is positioned within the rear compartment 450. As shown in FIG. 25, an upper end of the vehicle controller 100 is coupled (e.g., bolted) to the upper frame rails 380, and a lower end of the vehicle controller 100 is coupled to the lower frame rails 374.

### Storage Compartments

In some embodiments, the battery pack 340 includes batteries utilizing a lithium-ion battery chemistry (e.g., includes at least one lithium-ion battery). Other golf carts utilize alternative battery technologies, such as lead acid batteries, that are less space efficient than lithium-ion batteries. Accordingly, the battery pack 340 of the vehicle 10 is capable of providing similar performance to the other golf carts while requiring less space. By utilizing a lithium-ion battery pack, the vehicle 10 is provided with vacant space within the body 20.

Referring to FIGS. 6-16, the position of the battery pack 340 within the body 20 is shown. The battery pack 340 is positioned within a storage volume, shown seat storage volume 400, within the seat box 310. The seat box 310 includes a pair of side walls 402 and a front wall 404. The side walls 402 are positioned on the left and right sides of the vehicle 10, respectively. The side walls 402 extend substantially vertically and longitudinally and are laterally offset from one another. The front wall 404 extends laterally between the side walls 402. The side walls 402 and the front wall 404 extend upward from the floor 312 to the seat bottom 300. Accordingly, the seat storage volume 400 is defined between the side walls 402, between the floor 312 and the seat bottom 300, and rearward from the front wall 404.

The seat storage volume 400 is further divided into a series of storage compartments or storage volumes, shown as battery compartment 410 and side compartments 412. Specifically, the seat storage volume 400 is divided or partitioned by (a) a first frame rail subassembly including a first lower frame rail 374, a first upper frame rail 380, and a first bracket 384 and (b) a second frame rail subassembly including a second lower frame rail 374, a second upper frame rail 380, and a second bracket 384. The frame rail subassemblies extend longitudinally, substantially parallel to one another.

The battery compartment 410 is defined between the first frame rail subassembly and the second frame rail subassembly. Accordingly, the battery compartment 410 is approximately centered within the seat storage volume 400. The battery compartment 410 contains the battery pack 340, such that the battery pack 340 is positioned between the first frame rail subassembly and the second frame rail subassembly.

In some embodiments, the battery pack 340 is positioned elsewhere within the vehicle 10, or the vehicle 10 includes one or more additional battery packs 340 positioned throughout the vehicle 10. As shown in FIGS. 6 and 17, a battery pack 340 may be positioned within the floor 312. The battery pack 340 may be positioned between a top surface of the floor 312 (e.g., a surface that defines the foot volume 316) and a bottom surface of the floor 312. The top and bottom surfaces of the floor 312 may be defined by flat sheets of material (e.g., sheet metal) extending above and below the frame 12 to define a battery compartment that receives the battery pack 340. The battery compartment may extend laterally between the lower frame rails 374, such that the battery pack 340 is contained between the lower frame rails 374. By utilizing space within the frame 12 to store the battery pack 340, the vehicle 10 may be provided with additional storage capacity while freeing up other space within the vehicle 10 for storage.

Each side compartment 412 is positioned laterally outward from one of the frame rail subassemblies. Specifically, a first side compartment 412 is defined between the first frame subassembly and one of the side walls 402. A second side compartment 412 is defined between the second frame subassembly and the other of the side walls 402. Accordingly, the frame rail subassemblies are received between the side compartments 412, and the battery compartment 410 is received between the frame rail subassemblies.

The battery compartment 410 and the side compartments 412 may be used for storage. By way of example, the battery compartment 410 may be used to store the battery pack 340. Each side compartment 412 may be used to store equipment (e.g., sporting equipment), food and drink (e.g., within a cooler), components of the vehicle 10 (e.g., batteries, fluids, etc.), or other items. Items placed within the seat storage volume 400 may be enclosed and protected by the seat box 310 and the seat bottom 300.

In some embodiments, the battery compartment 410 and/or the side compartments 412 are selectively accessible through an opening defined along the top of the seat box 310. In some such embodiments, the seat bottom 300 is repositionable to permit access to this opening. The seat bottom 300 may be repositionable between (a) a use position in which the seat bottom 300 rests atop and is supported by the seat box 310 and/or the brackets 384 and (b) an access position in which the opening to the seat storage volume 400 is uncovered. By way of example, the seat bottom 300 may be pivotally coupled to the seat box 310, such that the seat bottom 300 may be lifted upward to access the seat storage volume 400. By way of another example, the seat bottom 300 may be removably coupled to the frame 12, such that the seat bottom 300 is removed to access the seat storage volume 400.

Referring to FIGS. 4-16, the vehicle 10 further includes a deployable storage assembly, shown as drawer assembly 420. The drawer assembly 420 is generally positioned between (a) the seat box 310 and (b) the fenders 360 and the rear tractive assembly 56. In other vehicles 10 (e.g., other golf vehicles) that do not utilize lithium-ion batteries, this space would normally be occupied by less space-efficient batteries. However, the small size of the battery pack 340 permits this space to be utilized for storage.

The drawer assembly 420 includes a sliding portion, shown as drawer 422, that extends laterally across the frame 12. The drawer 422 defines a storage compartment, shown as storage volume 424. The drawer 422 opens upward, such that the storage volume 424 is accessible through an opening at the top of the drawer 422. In some embodiments, the drawer 422 encloses the storage volume along the bottom, left, right, front, and rear sides (e.g., such that the drawer 422 forms a trough, bucket, or other upward-facing container). In some embodiments, the drawer 422 is longest in the lateral direction.

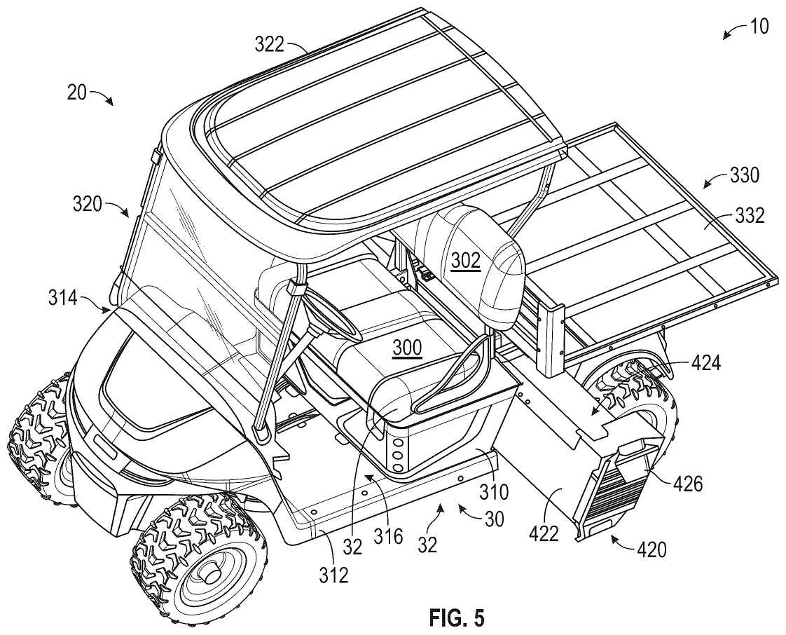

The drawer 422 is slidably coupled to the frame 12 and repositionable along a lateral axis between a retracted position (shown in FIGS. 4, 6-9, and 15) and an extended position (shown in FIGS. 5, 10-14, and 16). When in the retracted position, the drawer 422 extends between the lower portion 370 and the upper portion 372 of the frame 12. Accordingly, the drawer 422 is surrounded below by the lower frame rails 374 and above by the upper frame rails 380. Advantageously, the vertical spacing of the frame rails permits this placement of the drawer 422. Additionally, in the retracted position, the drawer 422 is enclosed within the body 20, protecting the contents of the drawer 422 from theft and ingress by outside contaminants.

When in the extended position, the drawer 422 is shifted laterally outward, extending the drawer 422 out of the body 20. The extended position of the drawer 422 exposes the storage volume 424, permitting a user to add items to the storage volume 424 or remove items from the storage volume 424. Specifically, a user may access the storage volume 424 from above. Accordingly, a user may place the drawer 422 in the extended position when adding or removing items and may place the drawer 422 in the retracted position when storing and/or transporting items.

The drawer assembly 420 includes a pair of end caps, panels, doors, or barriers, shown as drawer cap 426 and stationary cap 428. The drawer cap 426 is fixedly coupled to a first lateral end of the drawer 422, such that the drawer cap 426 moves with the drawer 422 relative to the frame 12. The stationary cap 428 is positioned adjacent a second end of the drawer 422 opposite the first end and is fixedly coupled to the frame 12. Accordingly, the drawer 422 and the drawer cap 426 are movable together relative to the stationary cap 428. In some embodiments, the drawer cap 426 and the stationary cap 428 are substantially symmetrical about a longitudinal centerline of the vehicle 10. The drawer cap 426 and the stationary cap 428 may visually obscure (e.g., hide) the drawer 422 when the drawer 422 is in the retracted position. As shown, the drawer cap 426 is positioned on the left side of the vehicle 10 and the stationary cap 428 is positioned on the right side of the vehicle 10, such that the drawer assembly 420 extends leftward when the drawer 422 is extended. In other embodiments, the drawer cap 426 is positioned on the right side of the vehicle 10 and the stationary cap 428 is positioned on the left side of the vehicle 10, such that the drawer assembly 420 extends rightward when the drawer 422 is extended.

The drawer 422 and the drawer cap 426 are slidably coupled to the frame 12 by one or more drawer slides, linear bearings, or sliding guides. A first drawer slide, shown in FIG. 12 as drawer slide 430, is positioned along an underside of the drawer 422 and slidably couples the drawer 422 to the frame 12. The drawer support 392 is coupled to the drawer 422. In some embodiments, the drawer support 392 also includes a drawer slide to facilitate sliding support of the drawer 422.

Referring to FIG. 2, the vehicle 10 further includes an actuator, shown as drawer actuator 440, operatively coupled to the vehicle controller 100. The drawer actuator 440 is configured to move the drawer 422 relative to the frame 12. By way of example, the drawer actuator 440 may include a linear actuator (e.g., an electric linear actuator, a hydraulic cylinder, etc.) that is coupled to the frame 12 and the drawer 422. The drawer actuator 440 may extend to move the drawer 422 toward the extended position or retract to move the drawer 422 toward the retracted position. Accordingly, the drawer actuator 440 may facilitate moving the drawer 422 without requiring manual user intervention. In other embodiments, the drawer actuator 440 is omitted, and the drawer 422 is moved manually.

Referring still to FIG. 2, the vehicle 10 further includes a latch or lock, shown as drawer lock 442, operatively coupled to the vehicle controller 100. The drawer lock 442 is configured to selectively limit movement of the drawer 422 relative to the frame 12. By way of example, the drawer lock 442 may include a latch that engages to hold the drawer 422 in the retracted position and/or a latch that engages to hold the drawer 422 in the extended position. To facilitate remote operation, the drawer lock 442 may include an actuator (e.g., a hydraulic cylinder, a solenoid, etc.) that actuates the latch. Beneficially, the drawer lock 442 may prevent the drawer 422 from unintentionally opening or closing.

In some embodiments, the vehicle controller 100 operates the drawer actuator 440 and/or the drawer lock 442 in response to a command from a user. The vehicle controller 100 may receive commands through the operator interface 48 and/or through a user device 232. By way of example, the user may provide a command or instruction to open the drawer 422, to close the drawer 422, to lock the drawer lock 442, and/or to unlock the drawer lock 442. In other embodiments, the drawer actuator 440 and/or the drawer lock 442 are controlled without the use of the vehicle controller 100 (e.g., electrically by supplying power through a switch or button, mechanically by operating a key or crank, etc.).

Referring to FIGS. 14, 15, and 25, the vehicle 10 has a storage volume or storage space, shown as rear compartment 450. The rear compartment 450 is defined rearward of the drawer assembly 420 and the front row seating 32 (e.g., behind the seat bottom 300 and the seat back 302). The rear compartment 450 extends laterally between the fenders 360 and below the bed 332. The rear compartment 450 receives the electric motor 350, the power transmission 352, the axles 354, and the bed actuator 336. In some embodiments, the rear compartment 450 provides sufficient space for the rear tractive assembly 56 to be inverted (e.g., such that the electric motor 350 faces rearward instead of forward).

Referring to FIG. 25, the arrangement of the rear tractive assembly 56 within the rear compartment 450 is shown. The power transmission 352 is positioned between the axles 354 of the rear tractive assembly 56 and extends forward to couple to the electric motor 350. The electric motor 350 is oriented laterally (e.g., centered about a lateral axis that extends parallel to the axles 354). The electric motor 350 is offset forward of the axles 354. In some embodiments, the axles 354 and the electric motor 350 are centered about a horizontal plane. In other embodiments, the electric motor 350 is positioned further forward in the vehicle 10, and the power transmission 352 includes a draft shaft that extends longitudinally to couple the electric motor 350 and the axles 354.

Referring to FIGS. 4-19, the position of the drawer assembly 420 relative to the other components of the vehicle 10 is shown. The drawer 422 extends rearward of (e.g., more longitudinally rearward than) the front tractive assembly 58, the dash assembly 314, the foot volume 316, the front row seating 32, the seat box 310, the battery pack 340, and the seat storage volume 400. The drawer 422 extends forward of (e.g., more longitudinally forward than) the rear tractive assembly 56, the fenders 360, and the bed 332. The drawer 422 extends lower than (e.g., has a lower vertical coordinate than) the front row seating 32, the seat box 310, the battery pack 340, and the bed 332. The drawer 422 extends below (e.g., is overlapped by the plan view footprint of) the bed 332. The drawer 422 extends higher than (e.g., has a higher vertical coordinate than) the floor 312, the lower frame rails 374, and the wheels 356. The drawer 422 extends above (e.g., overlaps the plan view footprint of) the electric motor 350. The drawer 422 extends between the lower portion 370 and the upper portion 372 of the frame 12 (e.g., passes through an aperture defined between a lower frame rail 374 and an upper frame rail 380).

As shown, the front and rear sides of the drawer assembly 420 are inclined (e.g., not vertical or horizontal). The seat box 310 and the fenders 360 have similar, corresponding shapes. Accordingly, the seat box 310 extends above the drawer assembly 420. Similarly, the drawer assembly 420 extends above the fenders 360.

When the drawer 422 is extended, the drawer assembly 420 extends laterally outward beyond other components of the vehicle 10. Specifically, the drawer 422 and the drawer cap 426 extend laterally outward beyond the seat box 310, the bed 332, the left fender 360, the floor 312, and the wheels 356. This lateral extension may facilitate unobstructed access to the storage volume 424 by a user.

In some embodiments, the drawer cap 426 and/or the stationary cap 428 are instead configured as a door or hatch that is pivotally coupled to the frame 12 and/or the body 20. By way of example, the drawer cap 426 may pivot or rotate about a longitudinal (e.g., horizontal) axis positioned below the drawer cap 426, such that the drawer cap 426 opens downward. By way of another example, the drawer cap 426 may pivot or rotate about a longitudinal (e.g., horizontal) axis positioned above the drawer cap 426, such that the drawer cap 426 opens upward. By way of another example, the drawer cap 426 may pivot or rotate about an upwardly extending (e.g., vertical) axis positioned forward of the drawer cap 426, such that the drawer cap 426 opens forward. By way of another example, the drawer cap 426 may pivot or rotate about an upwardly extending (e.g., vertical) axis positioned rearward of the drawer cap 426, such that the drawer cap 426 opens rearward. The stationary cap 428 may have similar pivotal movements.

In some embodiments, the drawer cap 426 is pivotally coupled to the frame 12 and/or the body 20. In some such embodiments, the drawer cap 426 is decoupled from the drawer 422, and the drawer 422 is configured to slide independent of the drawer cap 426. By way of example, a user may open the drawer cap 426, then slide the drawer 422 outward past the drawer cap 426 to access the storage volume 424. In other embodiments, the drawer 422 is omitted, and the portion of the body 20 adjacent to the drawer assembly 420 defines the storage volume 424.

In some embodiments, the stationary cap 428 is pivotally coupled to the frame 12 and/or the body 20. By way of example, a user may open the stationary cap 428 to provide access from a side of the vehicle 10 opposite the drawer cap 426. In embodiments where the drawer 422 is present, the stationary cap 428 may provide an alternative point of access for the drawer 422 and/or a point for accessing a volume between the drawer 422 and the stationary cap 428 that would otherwise be inaccessible. In embodiments where the drawer 422 is omitted, the stationary cap 428 and the drawer cap 426 may each be pivotable to permit access to a continuous lateral storage volume 424 from both sides of the vehicle 10.

Although the drawer 422 is shown as moving laterally, in other embodiments the drawer 422 is movable in a different direction. By way of example, the drawer 422 may be opened and closed by moving along a longitudinal axis. In one such example, a drawer 422 is placed within the rear compartment 450, and the drawer 422 is opened by moving the drawer 422 rearward. Such a rearward-opening drawer may replace the drawer 422 of the drawer assembly 420 or be provided in addition to the drawer 422 of the drawer assembly 420. In another such example, the drawer 422 is opened by moving the drawer 422 forward.

In some embodiments, the drawer assembly 420 is partially or completely sealed (e.g., weatherproofed). By way of example, the drawer cap 426 may engage the body 20 when the drawer 422 is in the closed position. The drawer cap 426 may include a seal made from a compliant material (e.g., rubber, fabric, etc.) that confirms to seal against the body 20. By sealing the drawer assembly 420 when closed, the seal may prevent ingress of contaminants (e.g., dust, grass, rocks, insects, etc.) into the storage volume 424 and contaminating objects contained within the drawer assembly 420. The seal may also facilitate maintaining a temperature of the storage volume 424 (e.g., insulating the storage volume 424).

Referring to FIG. 2, the vehicle 10 includes a climate control system (e.g., a heating system, a cooling system, a refrigeration system, etc.), shown as temperature regulation system 460, operatively coupled to the vehicle controller 100. Operation of the temperature regulation system 460 may be controlled by the vehicle controller 100 (e.g., in response to a user selection of a desired temperature through the operator interface 48). The temperature regulation system 460 may control a temperature of (e.g., heat and/or cool) the storage volume 424 and the objects within the storage volume 424. In some embodiments, the drawer 422 is insulated to facilitate maintaining a desired temperature of the storage volume 424.

In some embodiments, the temperature regulation system 460 includes a heater (e.g., an electric resistance heater) that provides thermal energy to the drawer 422 to maintain or increase a temperature of the storage volume 424. By way of example, such a configuration may be useful to heat food products (e.g., sausages, burgers, etc.) or to warm clothing (e.g., boots, socks, gloves, etc.). In some embodiments, the temperature regulation system 460 includes a cooling system (e.g., a refrigeration circuit) that removes thermal energy from to the drawer 422 to maintain or decrease a temperature of the storage volume 424. By way of example, such a configuration may be useful to cool food products (e.g., beverages, ice, etc.) or to cool clothing (e.g., boots, socks, gloves, etc.).

### Storage Under Bed

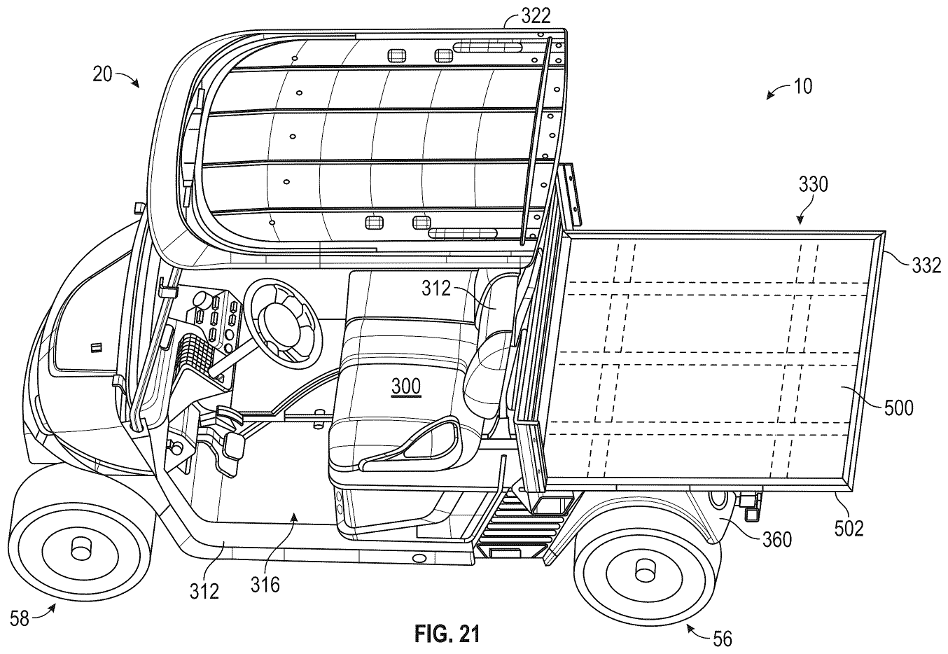

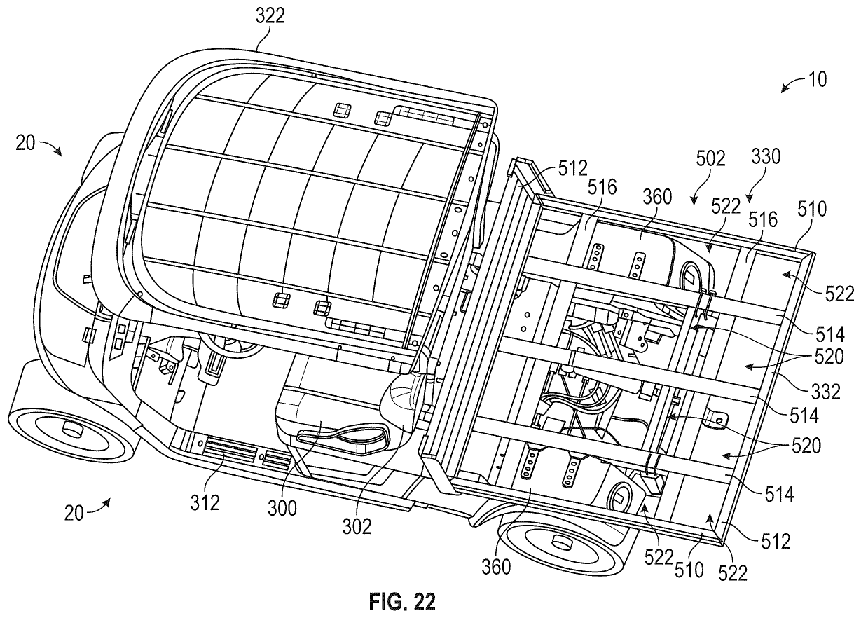

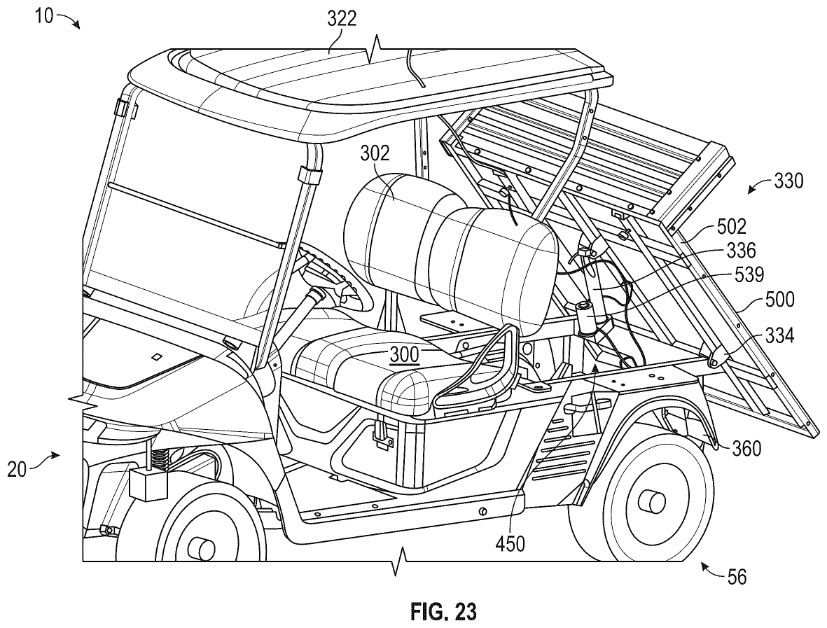

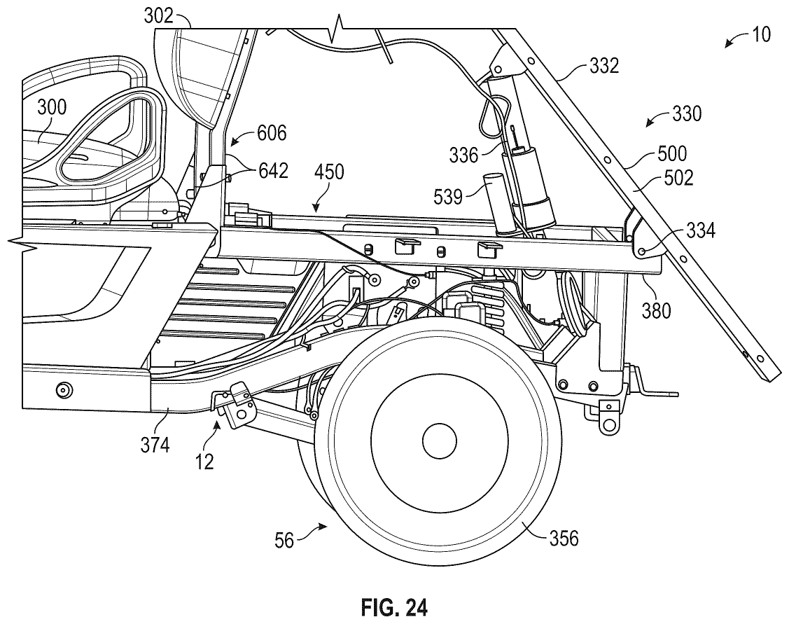

Referring to FIGS. 21-24, the vehicle 10 is shown with the bed assembly 330 according to an exemplary embodiment. The bed 332 of the bed assembly 330 is shown in the transport position in FIGS. 21 and 22 and in the unloading position in FIGS. 23 and 24. The bed 332 is pivotably coupled to the upper portion 372 of the frame 12 by the bushings 334. The bed 332 is raised into the loading position and lowered into the transport position by the bed actuator 336. The bed actuator 336 extends into the rear compartment 450 at least when the bed 332 is in the transport position. In the transport position, a front end portion of the bed 332 rests atop the upper frame rails 380. FIG. 25 shows the components within the rear compartment 450 beneath the bed 332.

Referring to FIGS. 21-24 and 26, the bed 332 includes a top panel, load-bearing panel, or top panel assembly, shown as bed top 500, and a structural assembly or subframe, shown as bed frame 502. The bed top 500 defines a top surface of the bed 332 that engages a load of the bed 332 (e.g., a payload, material, items, etc.) to support the load. With the bed 332 in the transport position, the bed top 500 may extend within a horizontal plane. The bed frame 502 is fixedly coupled to the bed top 500 and extends beneath the bed top 500. The bed frame 502 supports the bed top 500 and couples the bed top 500 to the bushings 334 and the bed actuator 336.

Referring to FIG. 22, the bed frame 502 is shown according to an exemplary embodiment. The bed frame 502 includes a series of frame members that are fixedly coupled (e.g., welded) to one another to form the bed frame 502. The bed frame 502 includes a pair of longitudinal frame members, shown as outer longitudinal members 510, and a pair of lateral frame members, shown as outer lateral members 512. The outer longitudinal members 510 are laterally offset from one another, and the outer lateral members 512 are longitudinally offset from one another. The outer lateral members 512 extend laterally from one of the outer longitudinal members 510 to the other of the outer longitudinal members 510. Together, the outer longitudinal members 510 and the outer lateral members 512 form an outer perimeter of the bed frame 502.

The bed frame 502 further includes a series of longitudinal frame members, shown as inner longitudinal members 514, and series of lateral frame members, shown as inner lateral members 516. Specifically, the bed frame 502 is shown to three of the inner longitudinal members 514 and two of the inner lateral members 516. The inner longitudinal members 514 are positioned between the outer longitudinal members 510. The inner longitudinal members 514 extend longitudinally from one of the outer lateral members 512 to the other of the outer lateral members 512. The inner lateral members 516 are positioned between the outer lateral members 512. The inner lateral members 516 extend laterally from one of the outer longitudinal members 510 to the other of the outer longitudinal members 510. As shown, the inner lateral members 516 intersect the inner longitudinal members 514. In some embodiments, the inner lateral members 516 and/or the inner longitudinal members 514 are formed in multiple sections to permit the inner longitudinal members 514 and the inner lateral members 516 to occupy a common horizontal plane while intersecting one another. In some embodiments, the bed actuator 336 is coupled to the centermost of the inner longitudinal members 514.

The outer longitudinal members 510, the outer lateral members 512, the inner longitudinal members 514, and the inner lateral members 516 intersect one another to form a grid of openings or spaces. The bed frame 502 defines series of gaps, openings, passages, or apertures, shown as inner openings 520 and outer openings 522, that extend vertically through the bed frame 502. The inner openings 520 are defined between the inner longitudinal members 514. The inner openings 520 may be bounded longitudinally by the outer lateral members 512 and/or the inner lateral members 516. As shown, the bed frame 502 defines six of the inner openings 520. The outer openings 522 are defined between the inner longitudinal members 514 and the outer longitudinal members 510. The outer openings 522 may be bounded longitudinally by the outer lateral members 512 and/or the inner lateral members 516. As shown, the bed frame 502 defines six of the outer openings 522.

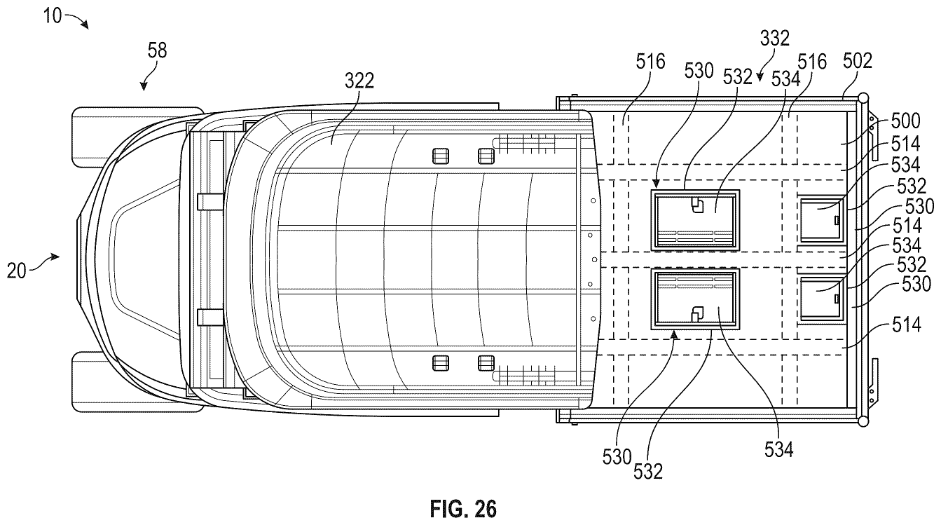

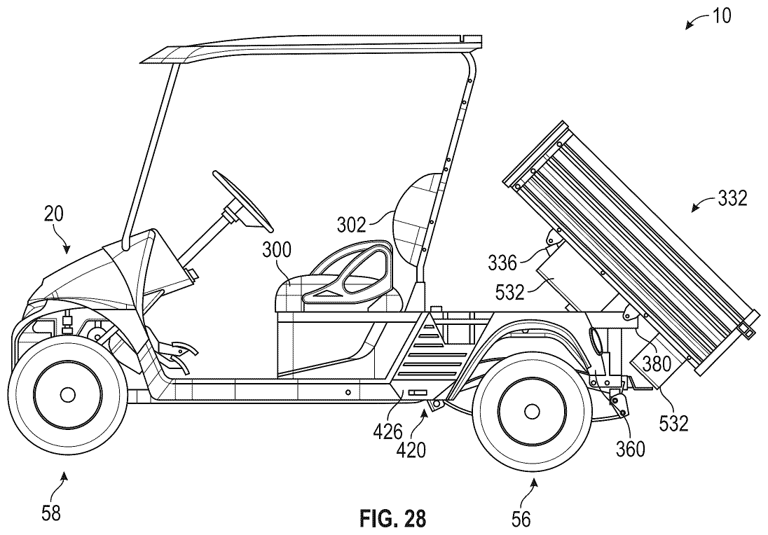

Referring to FIGS. 26-35, the vehicle 10 includes a series of storage assemblies (e.g., storage bins, storage drawers, etc.) positioned on or around the bed 332. The storage assemblies may include drawer assembly 420, storage bins 530, storage drawers 540, and/or other storage assemblies. Beneficially, the storage assemblies may facilitate storage of items (e.g., containers, tools, fasteners, materials, etc.) onboard the vehicle 10 in addition to the storage on the top surface of the bed 332 and without having to increase the footprint of the vehicle 10. The storage may leverage space that would otherwise go unoccupied, such as the space within the rear compartment 450. Due to the position of the electric motor 350 forward of the axles 354, the available space within the rear compartment 450 may increase relative to a configuration with the electric motor 350 above the axles 354, facilitating additional space to be used with the storage assemblies. The storage assemblies may be formed from metal, plastic, or other materials. While FIGS. 1-35 illustrate various possible configurations of the storage assemblies, it should be understood that these storage assemblies may be used alone or in combination with one another.

Referring to FIGS. 26-28, the vehicle 10 includes a series of storage assemblies, dry boxes, or bed storage bins, shown as storage bins 530. Each storage bin 530 includes a body, chassis, frame, bucket, bin, or base, shown as bin body 532, and a cover, hatch, door, portal, lid, or gate, shown as lid 534. The bin body 532 defines a storage compartment or inner volume, shown as storage volume 536, extending within the bin body 532 and configured to store one or more items. Specifically, the storage volume 536 extends downward into the bin body 532, such that an opening, passage, or aperture through which the storage volume 536 may be accessed is defined along a top of the bin body 532. By arranging the storage volume 536 to extend downward into the bin body 532, items may be held within the bin body 532 due to gravity.

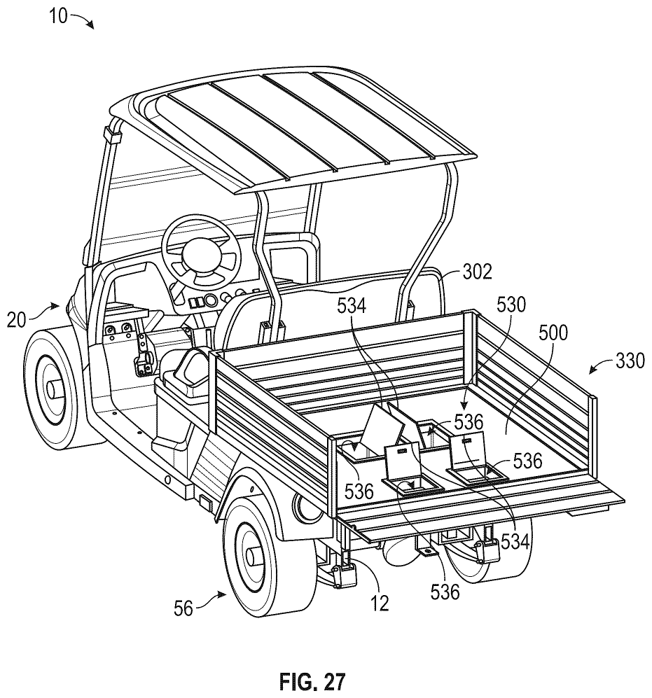

Each storage bin 530 includes a lid 534 movably coupled to the bin body 532, such that the lid 534 is repositionable between a closed position (shown in FIG. 26) and an open position (shown in FIG. 27). In the closed position, the lid 534 extends across the opening of the storage volume 536, limiting (e.g., preventing) access to the storage volume 536 from outside of the storage bin 530. In some embodiments, the lid 534 seals against the bin body 532 (e.g., forming an airtight or watertight seal) to prevent ingress of debris into the storage volume 536. In some embodiments, the lid 534 includes a lock that selectively fixedly couples the lid 534 to the bin body 532 in the closed position to prevent unauthorized access to the storage volume 536. The lock may be engaged and disengaged mechanically (e.g., with a key) or electronically (e.g., with a keypad, using a smartphone, etc.). In the open position, the lid 534 is moved away from the storage volume 536, such that access to the storage volume 536 is permitted. By way of example, a user may move the lid 534 to the open position and extend their hand down into the storage volume 536 to deposit or remove an item.

As shown, the lid 534 is pivotable relative to the bin body 532 (e.g., through a hinge that connects the lid 534 to the bin body 532). In such an embodiment, the lid 534 may be rotatable about an axis (e.g., an axis centered about the hinge) between the open position and the closed position. In other embodiments, the lid 534 is otherwise movable relative to the bin body 532. By way of example, the lid 534 may be slidable relative to the bin body 532 and slidable between the open position and the closed position. By way of another example, the lid 534 may be removably coupled to the bin body 532, such that the open position is a position in which the lid 534 is removed from the bin body 532.

In the embodiment of FIGS. 26-28, the storage bins 530 are coupled to the bed 332. Specifically, the bin bodies 532 are fixedly coupled to the bed 332, such that the bin bodies 532 move with the bed 332 relative to the frame 12. The bin bodies 532 may be directly coupled to the bed top 500 and/or the bed frame 502, such that the bed 332 supports the weight of the storage bins 530 and any items within the storage bins 530.

In order to accommodate the storage bins 530, the bed top 500 may define a series of vertical apertures or passages, each receiving one of the storage bins 530. As shown, the storage bins 530 are positioned such that the lids 534 are substantially flush with (e.g., fluish with, slightly above, slightly recessed into) the top surface of the bed top 500. Accordingly, the lids 534 and the bed top 500 may form a continuous top surface of the bed 332, such that the storage bins 530 may not obstruct placement of loads onto the bed top 500. Alternatively, the storage bins 530 may be recessed below the bed top 500, such that the lids 534 are provided with sufficient vertical clearance to be opened or removed while a load is positioned atop the bed top 500 and extends over portions of the storage bins 530.

By placing the lids 534 along the bed top 500 and exposing the storage bins 530, the lids 534 and the storage volumes 536 may be accessed in any position of the bed 332. By way of example, a user may open the lids 534 and insert their hands into the storage volumes 536 regardless of whether the bed 332 is in the transport position or the unloading position. Accordingly, coupling the storage bins 530 to the bed 332 may increase the accessibility of the storage bins 530.

The storage bins 530 extend from the top surface of the bed top 500, through the bed top 500 and the bed frame 502, below the bed 332, and into the rear compartment 450. To facilitate this placement of the storage bins 530 without intersecting the bed frame 502, the storage bins 530 are inserted through the gaps between the frame rails of the bed frame 502. The storage bins 530 may be received within the inner openings 520 and/or the outer openings 522. Storage bins 530 that extend through the inner openings 520 may be positioned between the fenders 360. Storage bins 530 that extend through the outer openings 522 may be positioned above the fenders 360. Accordingly, the storage bins 530 that extend through the inner openings 520 may be deeper than the storage bins 530 that extend through the outer openings 522, due to the space occupied by the fenders 360.

As shown, two of the storage bins 530 (i.e., forward storage bins) are received within inner openings 520 between the two inner lateral members 516, and two of the storage bins 530 (i.e., rearward storage bins) are received within inner openings 520 adjacent the rear outer lateral member 512. The forward storage bins are positioned forward of the bushings 334, and the rearward storage bins are positioned reward of the bushings 334. Accordingly, when the bed 332 moves from the transport position to the unloading position, the forward storage bins move upward and away from the rear compartment 450, and the rearward storage bins move downward and toward the frame 12. A depth of the rearward storage bins may be selected to prevent contact between (a) the rearward storage bins and (b) the frame 12 and/or the fenders 360 when the bed 332 is in the unloading position.

In some embodiments, the bed actuator 336 is laterally centered relative to the frame 12. The bed actuator 336 may extend between the pair of forward storage bins and between the rearward storage bins to connect to both the frame 12 and the bed 332. In some embodiments, the bed actuator 336 is oriented to minimize the lateral space occupied by the bed actuator 336 and maximize the room for the storage bins 530. As shown in FIGS. 24, 25, and 29, the bed actuator 336 includes an electric motor 539 that is oriented facing downward (e.g., along a bottom side of the bed actuator 336) to minimize the lateral space occupied by the bed actuator 336.

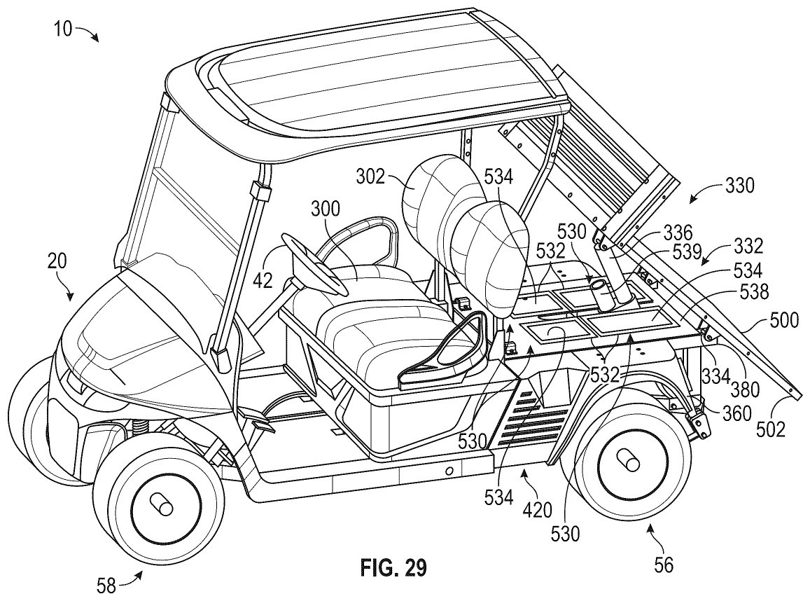

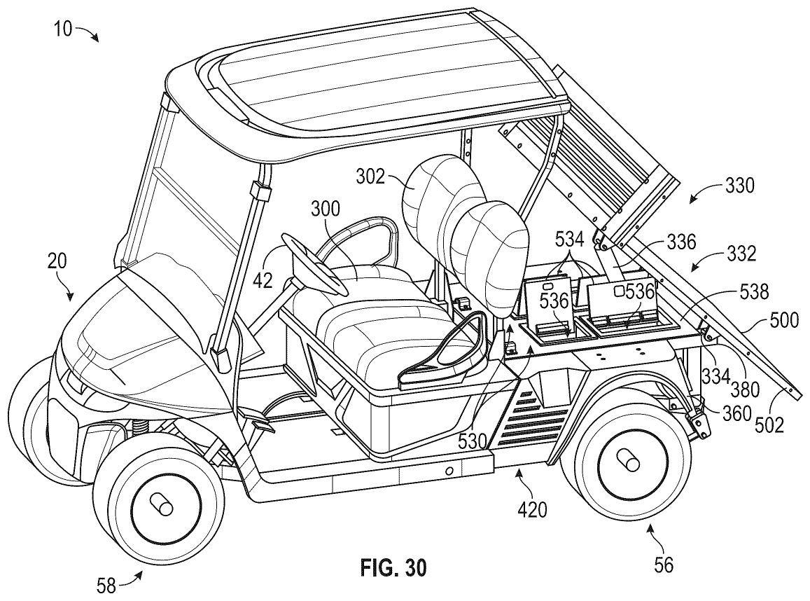

In the embodiment of FIGS. 29 and 30, the vehicle 10 is shown according to an alternative embodiment. The vehicle 10 of FIGS. 29 and 30 may be substantially similar to the vehicle 10 of FIGS. 26-28, except as otherwise specified herein. In the vehicle 10 of FIGS. 29 and 30, the storage bins 530 are coupled to the frame 12 by a subframe or support panel, shown as bin support plate 538. The bin support plate 538 is fixedly coupled to the tops of the upper frame rails 380, such that the rear compartment 450 extends beneath the bin support plate 538. Similar to the bed top 500 in FIGS. 26-28, the bin support plate 538 defines a series of vertical passages or apertures that each receive one of the storage bins 530. The bin support plate 538 fixedly couples the bin bodies 532 to the frame 12.

As shown, the vehicle 10 includes four of the storage bins 530, all arranged to extend downward into the rear compartment 450. Specifically, the storage bins 530 are arranged in two rows, each with two storage bins 530. The storage bins 530 are laterally offset from a longitudinal centerline of the frame 12. Accordingly, the bed actuator 336 extends between the storage bins 530, similar to the bed actuator 336 of FIGS. 26-28.

The storage bins 530 are positioned beneath the bed 332 when the bed 332 is in the transport position. Accordingly, the bed 332 blocks the storage bins 530 from above and limits (e.g., prevents) access to the storage bins 530 (e.g., the lids 534 and the storage volumes 536) when the bed 332 is in the transport configuration. When the bed 332 is in the unloading position, the bed 332 moves upward relative to the storage bins 530, permitting a user to access the storage volumes 536 of the storage bins 530. In some embodiments, the storage bins 530 include lids 534. In other embodiments, the lid 534 are omitted, and the bed 332 covers and protects the storage bins 530.

In an alternative embodiment, the bed 332 is omitted. In such an embodiment, the storage bins 530 may be accessible at all times. Access to the storage volumes 536 may be controlled by opening or closing the lids 534.

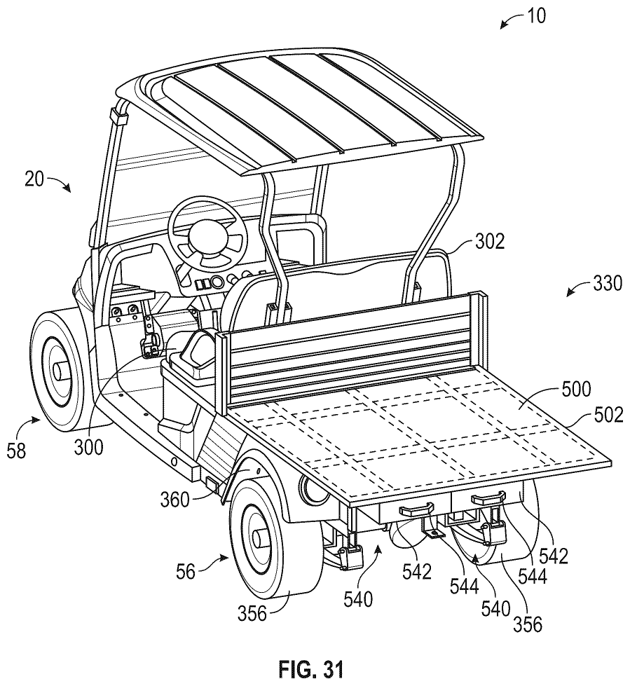

Referring to FIGS. 31-34, the vehicle 10 includes a series of storage assemblies or bed storage drawers, shown as storage drawers 540. Each storage drawer 540 includes a body, chassis, frame, bucket, bin, or base, shown as drawer body 542, and a user interface (e.g., a hook, a pull, a grip, etc.), shown as handle 544. The drawer body 542 is slidably coupled to the frame 12 by a pair of bearings or slides, shown as drawer slides 546. The drawer body 542 defines a storage compartment or inner volume, shown as storage volume 548, extending within the drawer body 542 and configured to store one or more items. Specifically, the storage volume 548 extends downward into the drawer body 542, such that an opening, passage, or aperture through which the storage volume 548 may be accessed is defined along a top of the drawer body 542. By arranging the storage volume 548 to extend downward into the bin body 532, items may be held within the drawer body 542 due to gravity. In some embodiments, each storage drawer 540 includes a lid (e.g., similar to the lid 534) that is movably coupled to the drawer body 542 and selectively limits access to the storage volume 548.

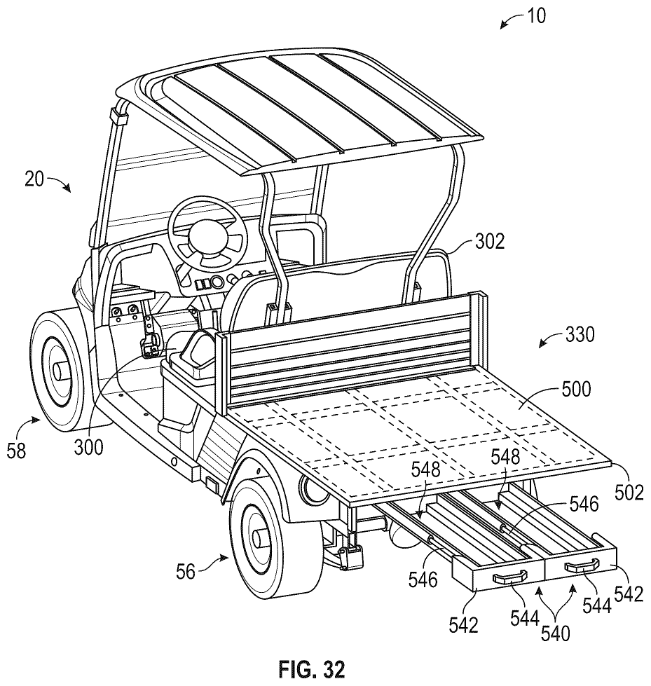

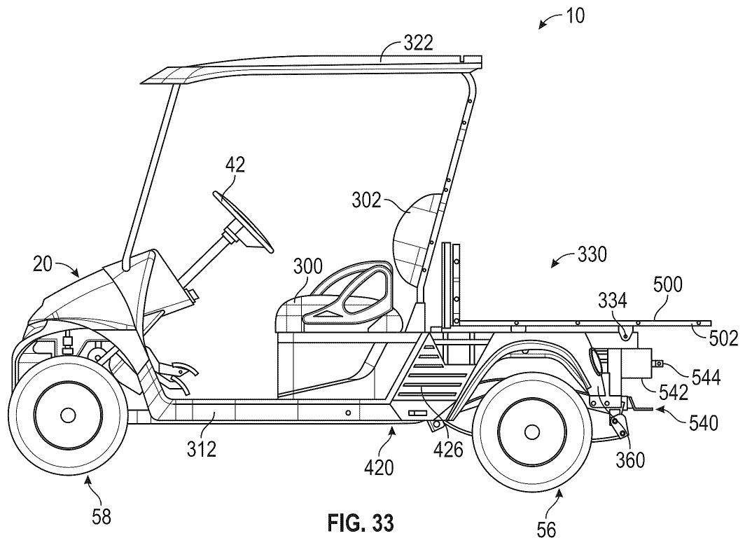

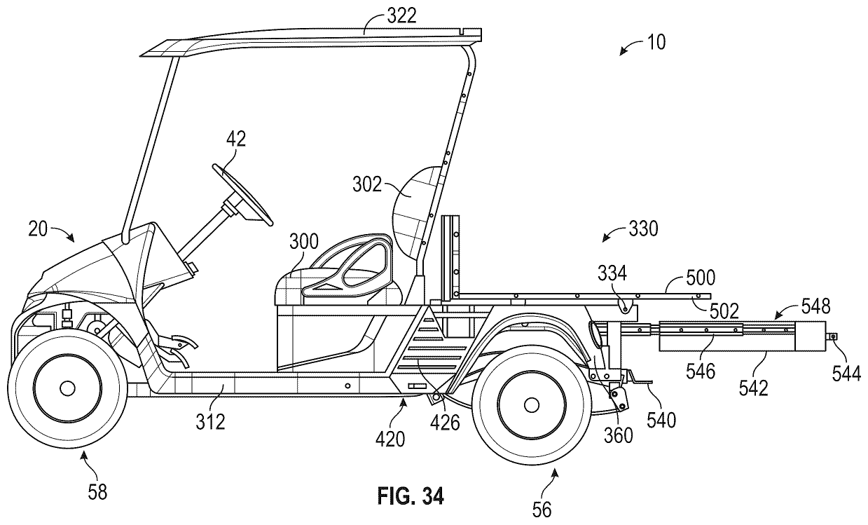

The drawer bodies 542 are arranged side-by-side, such that the drawer bodies 542 are arranged at the same height and laterally offset from one another. Each drawer body 542 is slidably coupled to the frame 12 by a pair of drawer slides 546, such that the drawer body 542 is repositionable between a retracted position or closed position (shown in FIGS. 31 and 33) and an extended position or open position (shown in FIGS. 32 and 34). Specifically, the drawer slides 546 couple the drawer bodies 542 to the upper portion 372 of the frame 12. The drawer slides 546 permit longitudinal movement of the drawer bodies 542, and the open position is rearward of the closed position.

In the closed position, the drawer bodies 542 extend between within the rear compartment 450. Specifically, the drawer bodies 542 extend between the fenders 360, below the bed 332, behind the front row seating 32, and above the electric motor 350, the power transmission 352, and the axles 354. As shown in FIG. 33, the drawer bodies 542 are positioned entirely beneath the bed 332 in the closed position. Accordingly, the bed 332 (e.g., the bed top 500) extends across the opening of the storage volume 548, limiting (e.g., preventing) access to the storage volume 548 from outside of the storage drawer 540. In some embodiments, the handle 544 or another portion of the storage drawer 540 includes a lock that selectively fixedly couples the drawer body 542 to the frame 12 in the closed position to prevent unauthorized access to the storage volume 548. The lock may be engaged and disengaged mechanically (e.g., with a key) or electronically (e.g., with a keypad, using a smartphone, etc.).

In the open position, a drawer body 542 is moved rearward such that the drawer body 542 extends rearward of the bed 332 and beyond the bed 332. The storage volume 548 is exposed instead of being completely covered by the bed 332, such that the storage volume 548 may be accessed by a user in the open position. The drawer body 542 may be moved between the open position and the closed position by a user by pulling or pushing on the as handle 544. Additionally or alternatively, the storage drawers 540 may each include a drawer actuator 440 that repositions the drawer bodies 542. As shown, the drawer bodies 542 may be moved into the open position while the bed 332 is in the transport position. In some embodiments, the rear end of the bed 332 inhibits movement of the drawer bodies 542 to the open position when the bed 332 is raised, such that the drawer bodies 542 may not move to the open position when the bed 332 is in the unloading position.

The drawer slides 546 may be positioned such that the bed actuator 336 extends between the paths of the drawer bodies 542. Accordingly, the bed actuator 336 may extend between the drawer bodies 542 when the drawer bodies 542 are in the closed positions. Similar to the arrangements including the storage bins 530, the lateral space occupied by the bed actuator 336 may be minimized to maximize the widths of the storage drawers 540.

In an alternative embodiment, the drawer bodies 542 are stationary and open rearward instead of or in addition to opening upward. In such an embodiment, items may be inserted or retrieved by moving the items longitudinally beneath the bed 332. Such a storage volume 548 may be useful when storing long, thin items beneath the bed 332. By way of example, such a storage volume 548 my store fishing poles, ski or snowboarding gear, and/or long guns. By way of another example, such a storage volume 548 may be used to store ramps that connect to a rear end of the bed 332 to permit driving wheeled devices onto the bed top 500 from the ground while the bed 332 remains in the transport position.

In an alternative embodiment, the bed 332 is omitted. In such an embodiment, the storage drawers 540 may be accessible at all times. Repositioning the drawer bodies 542 may facilitate access to the storage volumes 548 of particular drawers from certain user positions. In such embodiments, the storage drawers 540 may include lids 534 to control access to the storage volumes 548 and prevent ingress of debris.

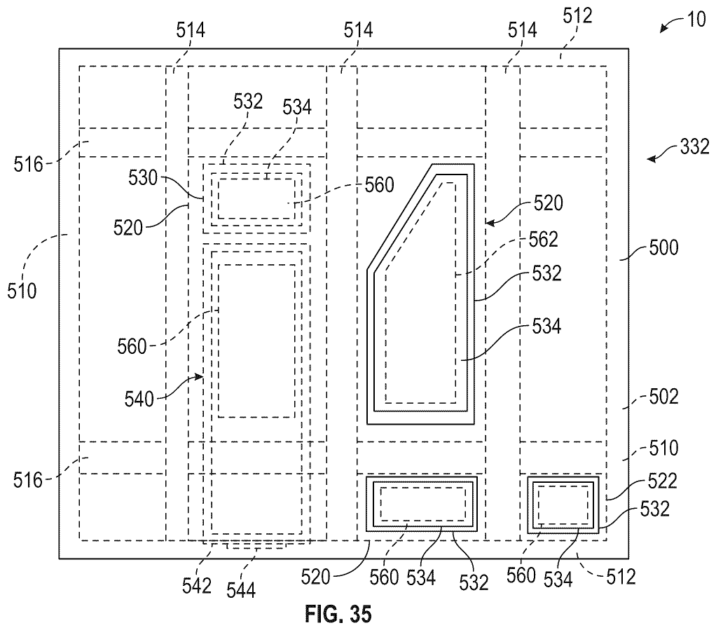

Referring to FIG. 35, an embodiment of the vehicle 10 is shown including the various storage assemblies discussed herein. FIG. 35 shows the portion of the vehicle 10 including the bed 332 and the components beneath the bed 332. FIG. 35 may represent any of the vehicles 10 shown herein, such that the vehicle 10 of FIG. 35 may further include the drawer assembly 420.

As shown in FIG. 35, the vehicle 10 includes a first storage bin 530 positioned within a rightmost and rearmost of the outer openings 522. The first storage bin 530 is received between the right outer longitudinal member 510, the rear outer lateral member 512, an inner longitudinal member 514, and an inner lateral member 516. The first storage bin 530 is coupled to the bed 332, such that the lid 534 is exposed and accessible from above the bed 332 (e.g., similar to the storage bins 530 of FIGS. 26-28). The first storage bin 530 has a rectangular footprint and receives an item, shown as storage container 560 (e.g. a toolbox, a tackle box, a tray, etc.). The storage container 560 may be removable from the first storage bin 530 as desired by an operator.

The vehicle 10 includes a second storage bin 530 positioned within a rearmost of the inner openings 520. The second storage bin 530 is received between the rear outer lateral member 512, a pair of the inner longitudinal members 514, and an inner lateral member 516. The second storage bin 530 is coupled to the bed 332, such that the lid 534 is exposed and accessible from above the bed 332 (e.g., similar to the storage bins 530 of FIGS. 26-28). The second storage bin 530 has a rectangular footprint and receives a storage container 560.

The vehicle 10 includes a third storage bin 530 positioned within an inner opening 520. The third storage bin 530 is received between a pair of the inner longitudinal members 514 and a pair of the inner lateral members 516. The third storage bin 530 is coupled to the bed 332, such that the lid 534 is exposed and accessible from above the bed 332 (e.g., similar to the storage bins 530 of FIGS. 26-28). The third storage bin 530 has a footprint that is shaped to correspond to an item, shown as tool 562, that is received within the third storage bin 530. The tool 562 has a non-uniform shape (e.g., not a rectangular shape). By way of example, the tool 562 may be a chainsaw, a miter saw, a grinder, a jackhammer, or another type of tool. By forming the bin body 532 and the lid 534 of the third storage bin 530 with a corresponding irregular shape to the tool 562, the third storage bin 530 may limit movement of the tool 562 and wasted space around the tool 562.

The vehicle 10 includes a fourth storage bin 530 positioned beneath the bed 332. The fourth storage bin 530 is coupled to the frame 12, such that the lid 534 is covered by the bed 332 until the bed 332 is moved to an unloading position (e.g., similar to the storage bins 530 of FIGS. 29 and 30). The fourth storage bin 530 has a rectangular footprint and receives a storage container 560.

The vehicle 10 includes a storage drawer 540 positioned beneath the bed 332. The storage drawer 540 is slidably coupled to the frame 12, such that the storage drawer 540 is covered by the bed 332 in the closed position and extends beyond the bed 332 in the open position (e.g., similar to the storage drawers 540 of FIGS. 31-34). The storage drawer 540 has a rectangular footprint and receives a storage container 560.

In the vehicle 10 of FIG. 35, the first, second, and third storage bins 530 and the storage drawer 540 may be accessible while the bed 332 is in the transport position. The first, second, third, and fourth storage bins 530 may be accessible while the bed 332 is in the unloading position.

### Personnel Transport Configuration

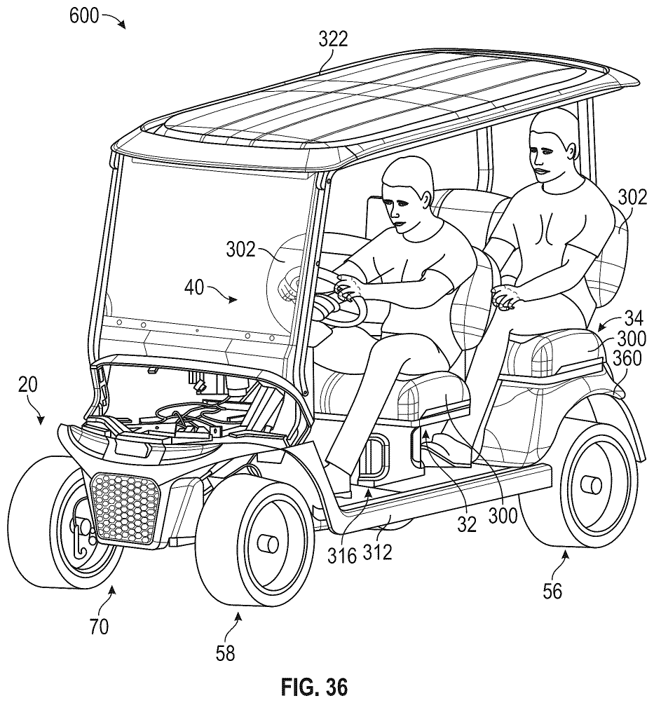

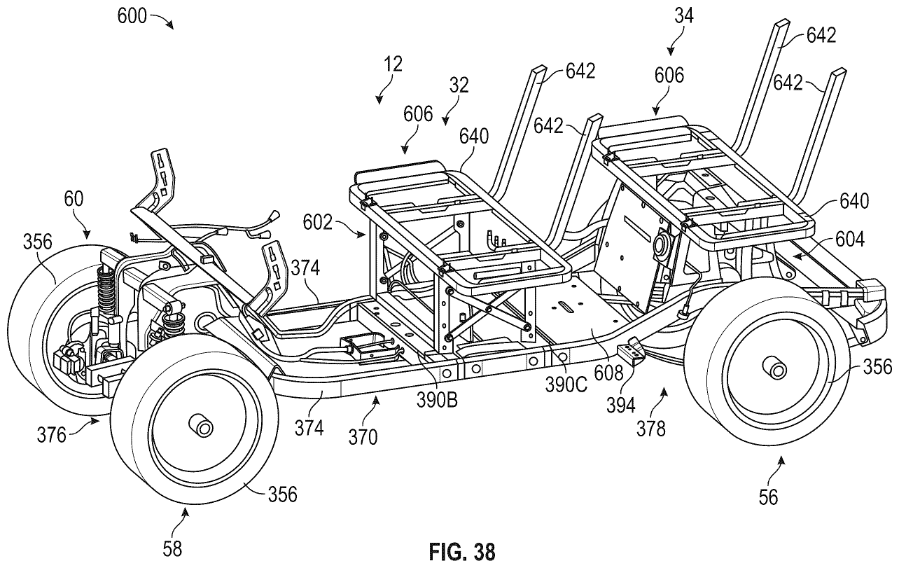

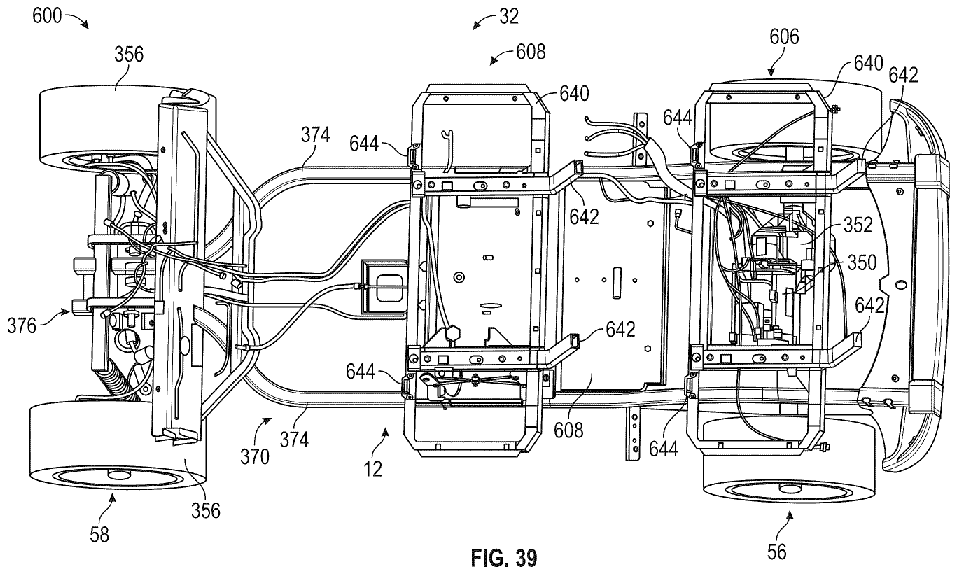

Referring to FIGS. 36-43, an alternative configuration of the vehicle 10 is shown as vehicle 600 according to an exemplary embodiment. The vehicle 600 may be substantially similar to the vehicle 10 of FIGS. 4-19 except as otherwise specified herein. In some embodiments, the vehicle 10 is configured as a golf vehicle. Specifically, the vehicle 10 may be configured as a personnel transport vehicle or passenger vehicle.

As shown in FIG. 36, the vehicle 600 omits the upper portion 372 of the frame 12 and the bed assembly 330. Instead, the vehicle 600 includes both the front row seating 32 and the rear row seating 34 (e.g., similar to the arrangement of the vehicle 10 of FIG. 1). Accordingly, the vehicle 600 may be able to transport additional passengers (e.g., two individuals in the front row seating 32 and two individuals in the rear row seating 34 for a total of four individuals) relative to the vehicle 10 of FIG. 4. Accordingly, whereas the vehicle 10 of FIG. 4 may be configured as a utility vehicle specialized in transporting items or material, whereas the vehicle 600 may be configured as a passenger vehicle specialized in transporting personnel.

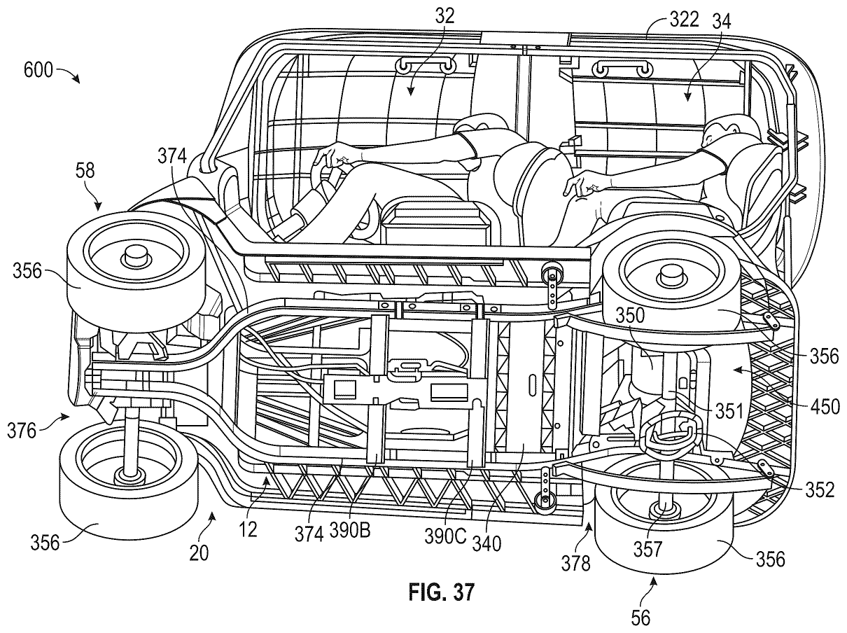

Referring to FIGS. 37-42, the vehicle 600 includes the lower portion 370 of the frame 12 in a similar configuration to the vehicle 10. In some embodiments, the lower portion 370 is the same or identical between the vehicle 10 and the vehicle 600. Accordingly, any description of the lower portion 370 of the vehicle 10 may also apply to the lower portion 370 of the vehicle 600, and any description of the lower portion 370 of the vehicle 600 may also apply to the lower portion 370 of the vehicle 10, except as otherwise stated.

As shown, the lower frame rails 374 extend longitudinally along the length of the vehicle 600 and are fixedly coupled to one another by a series of cross members (e.g., the cross members 390B, the cross member 390C, etc.). The front tractive assembly 58 is coupled to the lower frame rails 374 (e.g., by the suspension system 60) near a front end of the frame 12. The narrowed portions 376 of the lower frame rails 374 extend between the wheels 356 of the front tractive assembly 58. The rear tractive assembly 56 is coupled to the lower frame rails 374 (e.g., by the suspension system 60) near a rear end of the frame 12 and beneath the arched portions 378 of the lower frame rails 374. The arched portions 378 of the lower frame rails 374 extend between the wheels 356 of the front tractive assembly 58. A first lateral distance between the narrowed portions 376 of the lower frame rails 374 is less than a second lateral distance between the arched portion 378 (i.e., the narrowed portions 376 are closer together than the arched portions 378).

In place of the upper portion 372 of the frame 12, the frame 12 of the vehicle 600 includes a pair of seat frames, seat risers, seat support frames, uprights, or vertical standoffs, shown as front seat support 602 and rear seat support 604. The front seat support 602 supports the front row seating 32, and the rear seat support 604 supports the rear row seating 34. The front seat support 602 and the rear seat support 604 are each fixedly coupled to the lower portion 370 and extend upward from and above the lower portion 370. The front seat support 602 is offset longitudinally forward of the rear seat support 604. The front seat support 602 and the rear seat support 604 are each separately coupled to the lower portion 370, such that the front seat support 602 and the rear seat support 604 are separate from one another. By way of example, the rear seat support 604 may be removed from the lower portion 370 without removing the front seat support 602.

Each of the front row seating 32 and the rear row seating 34 include a seat subframe or internal seat frame, shown as seat frame 606. As shown in FIG. 24, the front row seating 32 of the vehicle 10 also includes a seat frame 606. In some embodiments, all of the seat frames 606 are the same or identical. In some embodiments, the front row seating 32 of the vehicle 10 and the front row seating 32 of the vehicle 600 are the same or identical.

Each seat frame 606 is coupled to and supports the seat bottom 300 and the seat back 302 of the corresponding seating. By way of example, the seat frame 606 of the front row seating 32 may couple the seat bottom 300 of the front row seating 32 to the seat back 302 of the front row seating 32. The seat frame 606 is coupled to the corresponding portion of the frame 12. By way of example, the seat frame 606 of the front row seating 32 of the vehicle 10 may be coupled to the upper portion 372 of the frame 12. By way of another example, the seat frame 606 of the front row seating 32 of the vehicle 600 may be coupled to the front seat support 602. By way of another example, the seat frame 606 of the rear row seating 34 of the vehicle 600 may be coupled to the rear seat support 604.

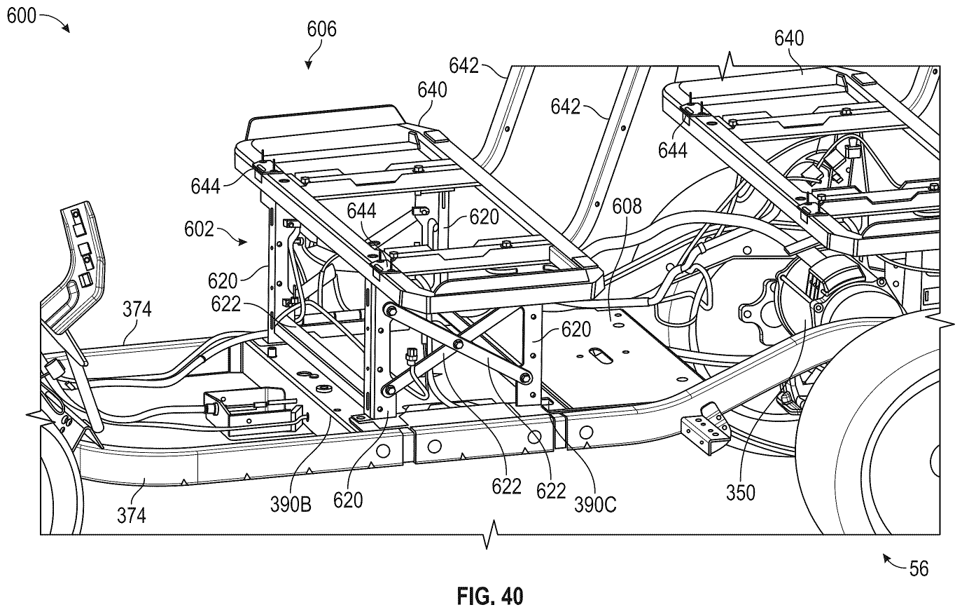

Referring to FIG. 40, the frame 12 further includes a horizontal portion or plate, shown as floor pan 608. The floor pan 608 rests atop the lower frame rails 374 and defines a top surface of the frame 12. The floor pan 608 is positioned longitudinally between the front seat support 602 and the rear seat support 604 (e.g., forward of the rear seat support 604 and rearward of the front seat support 602). Accordingly, the floor pan 608 may provide support for the feet of a passenger entering, exiting, or seated in the rear row seating 34.

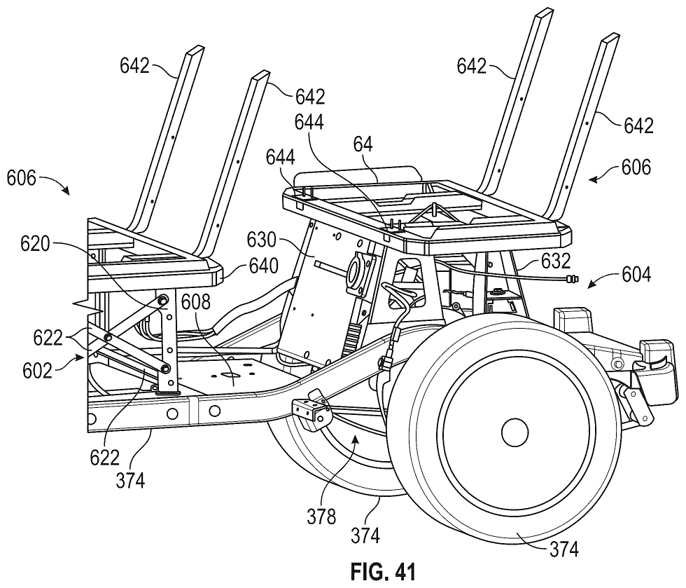

Referring to FIGS. 40 and 41, the front seat support 602 is shown according to an exemplary embodiment. The front seat support 602 extends laterally across the lower portion 370. The front seat support 602 is positioned laterally between the lower frame rails 374 and longitudinally between the cross member 390B and the cross member 390C.

The front seat support 602 includes a series of vertical frame members, shown as uprights 620, and a series of lateral and longitudinal frame members, shown as cross members 622. The uprights 620 each have a bottom end that is fixedly coupled (e.g., welded) to the lower portion 370 and a top end that is fixedly coupled to the seat frame 606 of the front row seating 32. The uprights 620 support the weight of the front row seating 32. In some embodiments, the uprights 620 are directly coupled to the lower frame rails 374. In other embodiments, the uprights 620 are indirectly coupled to the lower frame rails 374 (e.g., through the cross member 390B and the cross member 390C).

The cross members 622 extend between and support the uprights 620. On each laterally-facing side of the front seat support 602, a pair of cross members 622 extend longitudinally and form an X shape to limit relative longitudinal movement of the uprights 620. On the forward-facing side and the rearward-facing side of the front seat support 602, a cross members 622 extends laterally between two of the uprights 620 and limits relative lateral movement of the uprights 620.

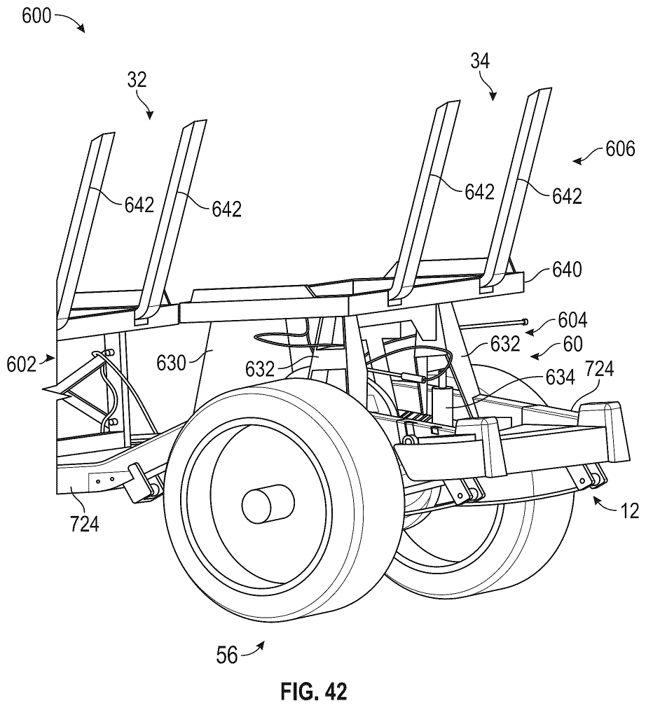

Referring to FIGS. 41 and 42, the rear seat support 604 is shown according to an exemplary embodiment. The rear seat support 604 extends laterally across the lower portion 370. The rear seat support 604 is positioned laterally between the lower frame rails 374. The rear seat support 604 is positioned longitudinally such that the rear tractive assembly 56 extends beneath the rear seat support 604 and the rear row seating 34.

The rear seat support 604 includes a series of vertical frame members, shown as front member 630 and rear members 632 (e.g., shock tower brackets). The front member 630 defines a front surface of the rear seat support 604. The front member 630 has a bottom end that is fixedly coupled (e.g., welded) to the lower portion 370 and a top end that is fixedly coupled to the seat frame 606 of the rear row seating 34. Specifically, the front member 630 is fixedly coupled to inner side surfaces of the arched portions 378 of the lower frame rails 374. Each rear member 632 has a bottom end that is fixedly coupled (e.g., welded) to the lower portion 370 and a top end that is fixedly coupled to the seat frame 606 of the rear row seating 34. Specifically, each rear member 632 is fixedly coupled the lower frame rails 374 behind the front member 630. Together, the front member 630 and the rear members 632 support the weight of the front row seating 32.

Referring to FIG. 42, the suspension system 60 includes one or more suspension elements (e.g., springs, dampers, etc.), shown as shock absorbers 634. Each shock absorber 634 has a lower end that is coupled to the rear tractive assembly 56 and an upper end that is coupled to one of the rear members 632. The shock absorber 634 may apply forces (e.g., spring forces, dampening forces, etc.) to control vertical movement of the rear tractive assembly 56 relative to the frame 12.

Referring to FIGS. 40-43, the seat frame 606 includes a horizontal frame member or subassembly, shown as frame bottom 640, and a pair of upright frame members, shown as back members 642. The frame bottom 640 is directly coupled to the upper portion 372, the front seat support 602, or the rear seat support 604, depending upon the embodiment. The frame bottom 640 extends substantially horizontally beneath the seat bottom 300. Accordingly, the frame bottom 640 supports the seat bottom 300. The back members 642 are fixedly coupled to the frame bottom 640 and extend upward and rearward from the frame bottom 640. The back members 642 extend along a back side of the seat back 302 and are fixedly coupled to the seat back 302. Accordingly, the back members 642 hold the seat back 302 in position relative to the frame 12.

The seat frame 606 further includes a pair of pivotable couplings or clips, shown as hinges 644. The hinges 644 are positioned along a front edge of the frame bottom 640 and along a front edge of the seat bottom 300. The hinges 644 pivotably couples the seat bottom 300 to the frame bottom 640, such that the seat bottom 300 is rotatable between a use position or lowered position (e.g., as shown in FIGS. 4 and 36) and a raised or access position above the lowered position. In the raised position, the seat bottom 300 permits access to a storage compartment beneath the seat (e.g., within the front seat support 602, within the rear seat support 604, within the upper portion 372, etc.).

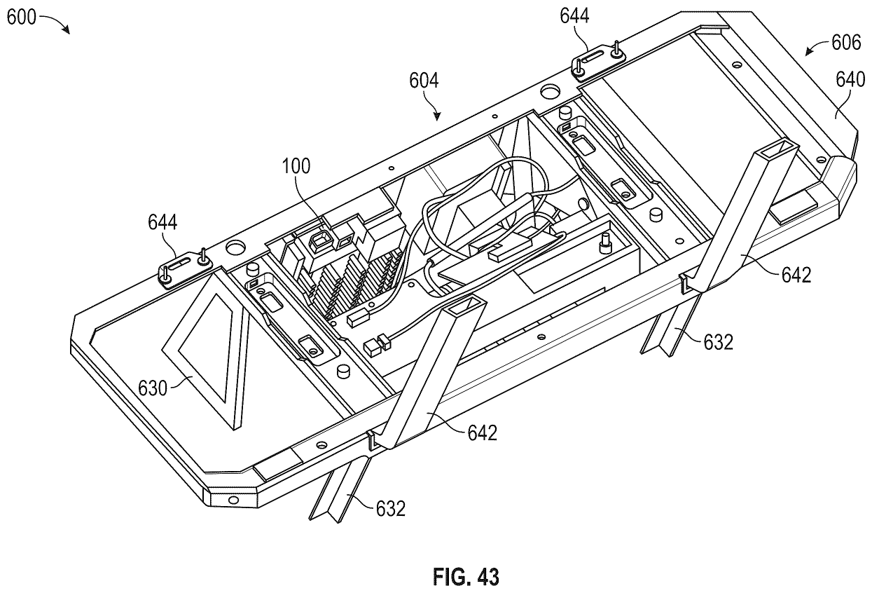

Referring to FIG. 43, the vehicle controller 100 may be positioned within the storage compartment of the rear seat support 604. As shown, the vehicle controller 100 is fixedly coupled to a rear side of the front member 630, such that the vehicle controller 100 is positioned beneath the rear seat support 604. The rear seat support 604 and the seat frame 606 may protect the vehicle controller 100 from contact with debris or other potential sources of damage. The seat bottom 300 of the rear row seating 34 may be raised to facilitate access to the vehicle controller 100.

Referring to FIGS. 25 and 43, the vehicle controller 100 is repositioned from the upper portion 372 to the rear seat support 604 between the vehicle 10 and the vehicle 600. However, in both vehicle configurations, the vehicle controller 100 is positioned above the rear tractive assembly 56 (e.g., in approximately the same longitudinal position). Accordingly, a common wiring harness may be used to connect to the vehicle controller 100 in both vehicle configurations without having to modify a length of the wiring harness.

### Common Base Assembly and Modular Subframes

Within a modular vehicle system, a common base assembly may be produced that is usable with two or more different application kits. Each application kit may include different features, perform different functions, or have different performance characteristics. The application kit for a desired application (e.g., transporting personnel, transporting equipment, etc.) may be selected during the manufacturing process to produce a vehicle suited for the desired application. By sharing a common base assembly between multiple different vehicles, the manufacturing complexity and inventory required to produce multiple different vehicles may be reduced.

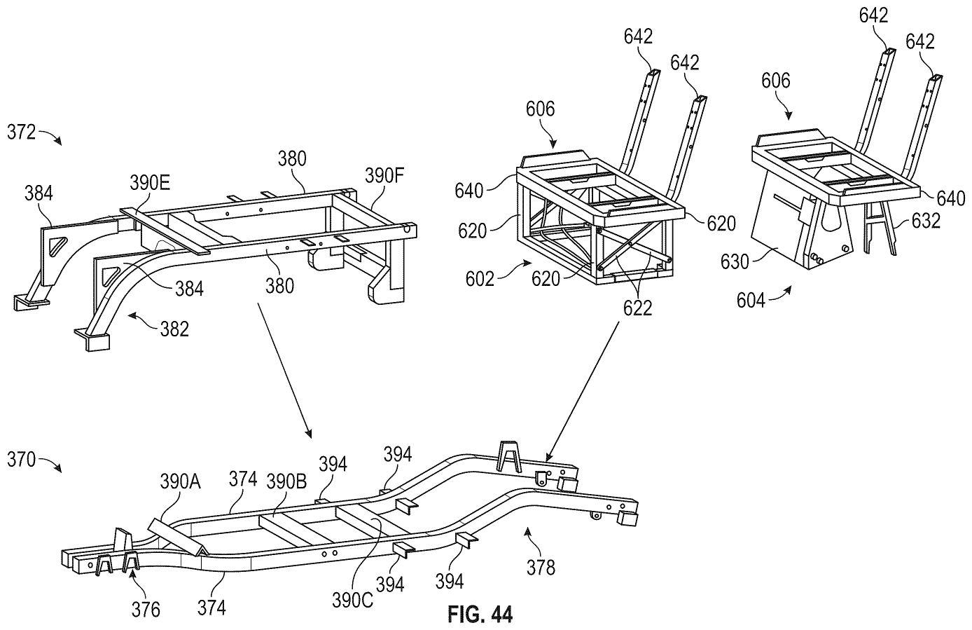

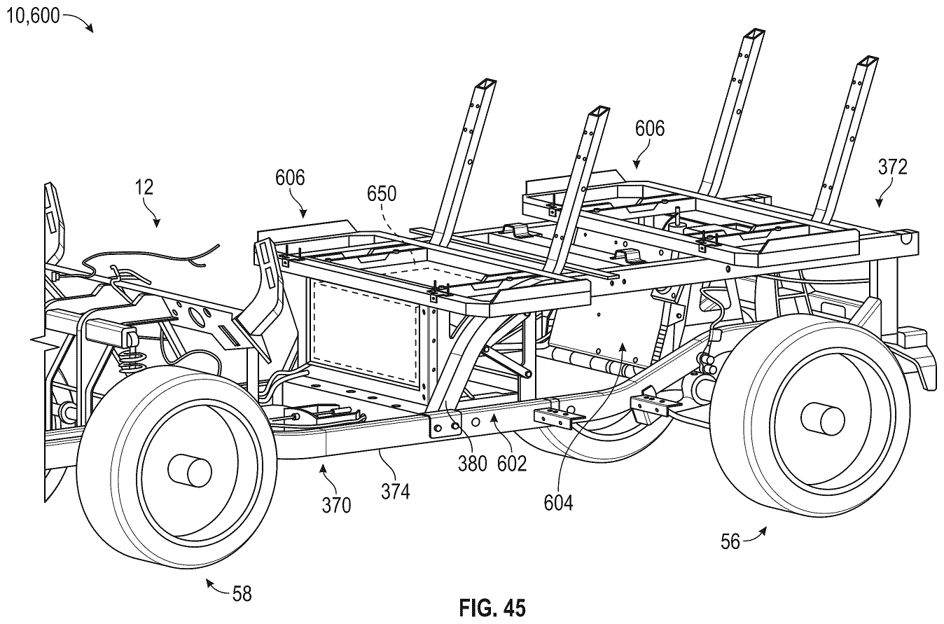

Referring to FIGS. 44 and 45, the vehicle 10 and the vehicle 600 may be part of a modular vehicle system. In this modular vehicle system, the vehicle 10 and the vehicle 600 share a subset of components (e.g., a common base assembly) that are the same or identical. A given base assembly may be outfitted with a first application kit (e.g., a hauler kit, an equipment transportation kit, etc.) to form the vehicle 10 or a second application kit (e.g., a personnel transporter kit, a passenger kit, etc.). Accordingly, a facility supplied with the base assemblies, the first application kits, and the second application kits may manufacture both the vehicle 10 and the vehicle 600.

The common base assembly includes components that are shared or common between the vehicle 10 and the vehicle 600. As shown in FIG. 44, the base assembly includes the lower portion 370 of the frame 12, which serves as the main structure of the base assembly. The base assembly further includes the rear tractive assembly 56 and the front tractive assembly 58, which are each coupled to the lower portion 370 similarly in both the vehicle 10 and the vehicle 600. Accordingly, the base assembly may act as a rolling chassis. The rolling chassis may be self-propelled (e.g., by the electric motor 350).

The first application kit includes the components necessary to convert the base assembly into the vehicle 10 (i.e., includes all of the components of the vehicle 10 that are not included in the base assembly). The first application kit includes the upper portion 372, the body 20, the front row seating 32, and the bed assembly 330. To manufacture the vehicle 10, the upper portion 372 is fixedly coupled to the lower portion 370 of the base assembly to form the frame 12 of the vehicle 10. The body 20, the front row seating 32, and the bed assembly 330 are then coupled to the frame 12 to complete the vehicle 10.

The second application kit includes the components necessary to convert the base assembly into the vehicle 600 (i.e., includes all of the components of the vehicle 600 that are not included in the base assembly). The second application kit includes the front seat support 602, the rear seat support 604, the body 20, the front row seating 32, and the rear row seating 34. To manufacture the vehicle 10, the front seat support 602 and the rear seat support 604 are fixedly coupled to the lower portion 370 of the base assembly to form the frame 12 of the vehicle 600. The body 20, the front row seating 32, and rear row seating 34 are then coupled to the frame 12 to complete the vehicle 600.

Referring to FIG. 45, the first application kit and the second application kit are shown overlaid onto a common base assembly, showing the relative positions of the first application kit and the second application kit. As shown, both application kits include electronic components (e.g., controllers, power converters, wires, etc.), shown as electronics 650, that control operation of the vehicle 10 or the vehicle 600. In both configurations, the electronics 650 are contained beneath the front row seating 32. By way of example, in the vehicle 10, the electronics 650 are positioned within a storage compartment defined by the lower portion 370 beneath the front row seating 32. By way of example, in the vehicle 10, the electronics 650 are positioned within a storage compartment defined by the front seat support 602 beneath the front row seating 32. In some embodiments, the electronics 650 include the vehicle controller 100. In some embodiments, the electronics 650 include all of the electronics of the respective vehicle (e.g., all of the controllers, etc.).

A method of manufacturing or producing vehicles may include providing (a) a series of base assemblies that are common to multiple vehicle variants (e.g., the vehicle 10 and the vehicle 600), (b) a first application kit for a first vehicle variant, and (c) a second application kit for a second vehicle variant. The method may further include coupling the first application kit to a first one of the base assemblies to form or provide the first vehicle variant. The method may further include coupling the second application kit to a second one of the base assemblies to form or provide a second vehicle variant. This method, when executed, may result in the manufacture of both the vehicle 10 and the vehicle 600.

As utilized herein with respect to numerical ranges, the terms “approximately,” “about,”“substantially,” and similar terms generally mean+/−10% of the disclosed values, unless specified otherwise. As utilized herein with respect to structural features (e.g., to describe shape, size, orientation, direction, relative position, etc.), the terms “approximately,” “about,” “substantially,” and similar terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules, and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof (e.g., the body 20, the operator controls 40, the driveline 50, the suspension system 60, the braking system 70, the sensors 90, the vehicle controller 100, etc.) and the site monitoring and control system 200 (e.g., the remote systems 240, the user portal 230, the user sensors 220, etc.) as shown in the various exemplary embodiments is illustrative only. Additionally, any element disclosed in one embodiment may be incorporated or utilized with any other embodiment disclosed herein.

What is claimed is:

1. A method for producing vehicles, the method comprising:
providing a plurality of base assemblies, each of the base assemblies including a base frame, a front tractive assembly coupled to the base frame, and a rear tractive assembly coupled to the base frame;
providing a first application kit including a first seat and an implement;
providing a second application kit including a second seat and a third seat;
coupling the first application kit to the base frame of a first base assembly of the plurality of base assemblies to provide a first vehicle variant; and
coupling the second application kit to the base frame of a second base assembly of the plurality of base assemblies to provide a second vehicle variant.

2. The method of claim 1, wherein the first base assembly and the second base assembly are the same.

3. The method of claim 1, wherein the first application kit further includes an upper frame coupled to the first seat and the implement, wherein coupling the first application kit to the base frame of the first base assembly includes coupling the upper frame of the first application kit to the base frame of the first base assembly.

4. The method of claim 3, wherein the implement includes a bed having a top surface configured to support a load, wherein the bed is positioned rearward of the first seat in the first vehicle variant.

5. The method of claim 4, wherein the first application kit further includes a bed actuator coupled to the upper frame and the bed, wherein the bed is pivotably coupled to a rear end portion of the upper frame, and wherein the bed actuator is configured to reposition the bed relative to the upper frame.

6. The method of claim 3, wherein the base frame of each of the base assemblies includes a first frame rail that extends longitudinally, wherein the upper frame includes a second frame rail coupled to the first seat and the implement, and wherein the second frame rail extends longitudinally above the first frame rail in the first vehicle variant.

7. The method of claim 6, wherein a front portion of the second frame rail meets the first frame rail of the first base assembly between the front tractive assembly and the rear tractive assembly in the first vehicle variant.

8. The method of claim 6, wherein the rear tractive assembly of the first base assembly extends beneath the second frame rail in the first vehicle variant.

9. The method of claim 1, wherein the second application kit includes (a) a first seat frame coupled to the second seat and (b) a second seat frame separate from the first seat frame and coupled to the third seat; and
wherein coupling the second application kit to the base frame of the second base assembly to provide the second vehicle variant includes coupling the first seat frame and the second seat frame to the base frame of the second base assembly.

10. The method of claim 9, wherein the first seat frame is longitudinally offset from the second seat frame in the second vehicle variant.

11. The method of claim 10, wherein the base frame of each of the base assemblies includes a first frame rail and a second frame rail that are laterally offset from one another; and
wherein coupling the second application kit to the base frame of the second base assembly to provide the second vehicle variant includes coupling the first seat frame and the second seat frame to both the first frame rail and the second frame rail of the base frame of the second base assembly.

12. The method of claim 10, wherein the rear tractive assembly of the second base assembly extends beneath the third seat and the second seat frame in the second vehicle variant.

13. The method of claim 10, wherein the first seat frame is positioned between the front tractive assembly and the rear tractive assembly of the second base assembly in the second vehicle variant.

14. The method of claim 1, wherein the base frame of each of the base assemblies includes a pair of frame rails that are laterally offset from one another;
wherein coupling the first application kit to the base frame of the first base assembly to provide the first vehicle variant includes coupling the first application kit to both of the frame rails of the first base assembly; and
wherein coupling the second application kit to the base frame of the second base assembly to provide the second vehicle variant includes coupling the second application kit to both of the frame rails of the second base assembly.

15. The method of claim 14, wherein each frame rail includes a front portion and a rear portion, wherein a first lateral distance between the front portions of the frame rails is less than a second lateral distance between the rear portions of the frame rails in each of the base assemblies.

16. The method of claim 15, wherein each of the front tractive assemblies includes a pair of front wheels, wherein each of the rear tractive assemblies includes a pair of rear wheels, wherein the front portions of the frame rails extend between the front wheels in each of the base assemblies, and wherein the rear portions of the frame rails extend between the rear wheels in each of the base assemblies.

17. A vehicle comprising:
a chassis including:
a pair of frame rails extending longitudinally and each including a front portion and a rear portion, wherein a first lateral distance between the front portions is less than a second lateral distance between the rear portions; and
a cross member extending laterally between the frame rails and fixedly coupled to the frame rails;
a front tractive assembly coupled to the chassis and including a pair of front wheels, wherein the front portions of the frame rails extend between the front wheels;
a rear tractive assembly coupled to the chassis, the rear tractive assembly including:
a first rear wheel and a second rear wheel, wherein the rear portions of the frame rails extend between the first rear wheel and the second rear wheel;
an axle coupled to the first rear wheel;
an electric motor longitudinally offset from the axle; and
a power transmission coupling the electric motor to the axle;
an upper frame coupled to the frame rails and extending above the chassis, wherein the rear tractive assembly extends beneath the upper frame; and
a seat coupled to the upper frame.

18. The vehicle of claim 17, further comprising a bed having a top surface configured to support a load, wherein the upper frame includes a pair of upper frame rails extending longitudinally and supporting the seat and the bed, wherein each of the upper frame rails is coupled to one of the frame rails of the chassis between the front tractive assembly and the rear tractive assembly.

19. The vehicle of claim 17, wherein the upper frame is a first seat frame and the seat is a first seat, further comprising:
a second seat frame coupled to the frame rails and positioned between the front tractive assembly and the rear tractive assembly; and
a second seat coupled to the second seat frame.

20. A method for producing vehicles, the method comprising:
providing a plurality of base assemblies, each of the base assemblies including:
a base frame including a pair of first frame rails that extend longitudinally and are laterally offset from one another, each of the first frame rails including a front portion and a rear portion, wherein a first lateral distance between the front portions of the first frame rails is less than a second lateral distance between the rear portions of the first frame rails;
a front tractive assembly including a pair of front wheels, wherein the front tractive assembly is coupled to the base frame such that the front portions of the first frame rails extend between the front wheels; and
a rear tractive assembly including a pair of rear wheels, wherein the rear tractive assembly is coupled to the base frame such that the rear portions of the first frame rails extend between the rear wheels;
providing a first application kit including:
an upper frame including a second frame rail;
a first seat coupled to the second frame rail;
a bed pivotably coupled to the second frame rail and having a top surface configured to support a load; and
a bed actuator coupled to the upper frame and the bed and configured to reposition the bed relative to the upper frame;
providing a second application kit including:
a second seat;
a first seat frame coupled to the second seat;
a third seat; and
a second seat frame separate from the first seat frame and coupled to the third seat;
coupling the upper frame of the first application kit to the base frame of a first base assembly of the plurality of base assemblies to provide a first vehicle variant, wherein in the first vehicle variant:
the bed is positioned rearward of the first seat;
the second frame rail extends longitudinally above one of the first frame rails and the rear tractive assembly; and
the second frame rail meets the one of the first frame rails between the front tractive assembly and the rear tractive assembly; and
coupling the first seat frame and the second seat frame of the second application kit to both of the first frame rails of the base frame of a second base assembly of the plurality of base assemblies to provide a second vehicle variant, wherein in the second vehicle variant:
the first seat frame is positioned between the front tractive assembly and the rear tractive assembly of the second base assembly; and
the rear tractive assembly of the second base assembly extends beneath the third seat and the second seat frame.
